(19) United States
(12) Patent Application Publication
(10) Pub. No.: US 2026/0361910 A1
(43) Pub. Date: Nov. 12, 2026

(54) IMAGE ENCODING/DECODING METHOD AND APPARATUS

(71) Applicant: INDUSTRY ACADEMY COOPERATION FOUNDATION OF SEJONG UNIVERSITY, Seoul (KR)

(72) Inventors: Yung-Lyul LEE, Seoul (KR); Su Yeon LIM, Namyangju-si, Gyeonggi-do (KR); Hyeon Ju SONG, Seoul (KR); Min Kyeong CHOI, Seoul (KR); Seong Han KIM, Seoul (KR)

(21) Appl. No.: 19/477,046

(22) PCT Filed: Apr. 16, 2024
(86) PCT No.: PCT/KR2024/005077

§ 371 Date: Oct. 20, 2025

(30) Foreign Application Priority Data
Apr. 21, 2023 (KR) 10-2023-0052851
Aug. 21, 2023 (KR) 10-2023-0109204
Apr. 16, 2024 (KR) 10-2024-0050556

(51) Int. Cl. H04N 19/52; H04N 19/105; H04N 19/159; H04N 19/176; H04N 19/60

(52) U.S. Cl. CPC H04N 19/52; H04N 19/105; H04N 19/159; H04N 19/176; H04N 19/60

(57) ABSTRACT

Provided are an image encoding method and apparatus, and an image decoding method and apparatus using affine-transform-based inter prediction. The affine-transform-based inter prediction comprises determining that a current block is predicted by an affine model, determining four control point motion vectors (CPMVs) of the current block, and predicting the current block according to the four CPMVs.

### TECHNICAL FIELD

The present invention relates to an image encoding/decoding method and apparatus, and more specifically, to an image encoding/decoding method and apparatus that performs inter prediction according to affine transform.

### BACKGROUND ART

Recently, the demand for high-resolution, high-quality images such as high definition (HD) image and ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image compression technology for images may be utilized.

As image compression technologies, there are various technologies, such as inter prediction technology that predicts pixel values included in a current picture from pictures before or after the current picture, intra prediction technology that predicts pixel values included in a current picture using pixel information within the current picture, and entropy encoding technology that assigns short codes to values with high frequency of appearance and long codes to values with low frequency of appearance. Using these image compression technologies, image data can be effectively compressed and transmitted or stored.

Meanwhile, as demand for high-resolution image increases, the demand for stereoscopic image content increases as a new image service. Discussions are underway on video compression technologies to effectively provide high-resolution and ultra-high-resolution stereoscopic image content.

### DISCLOSURE

### Technical Problem

An object of the present invention is to provide an image encoding/decoding method and apparatus that performs inter prediction according to affine transform.

Another object of the present invention is to provide a recording medium for storing a bitstream generated by an image encoding method or apparatus of the present invention.

The technical problems solved by the present invention are not limited to the above technical problems and other technical problems which are not described herein can be clearly understood by a person having ordinary skill in the technical field to which the present invention belongs from the description below.

### Technical Solution

In the present disclosure, provided is a video decoding method comprising determining that a current block is predicted by an affine model, determining four control point motion vectors (CPMVs) of the current block, and predicting the current block according to the four CPMVs.

According to one embodiment, the determining the four CPMVs of the current block may comprise determining a merge candidate list including at least one of a spatial merge candidate, a temporal merge candidate or a combined merge candidate of the current block when a prediction mode of the current block is a merge mode and determining the four CPMVs of the current block according to a merge candidate selected from the merge candidate list of the current block.

According to one embodiment, the determining the merge candidate list of the current block may comprise determining a spatial merge candidate of the current block from a CPMV of a spatially adjacent block of the current block when the spatially adjacent block of the current block is predicted by an affine model and determining a temporal merge candidate of the current block from a CPMV of a temporally corresponding block of the current block when the temporally corresponding block of the current block is predicted by an affine model.

According to one embodiment, the determining the spatial merge candidate of the current block may comprise determining a first CPMV, a second CPMV and a third CPMV of the spatial merge candidate from three CPMVs of the spatially adjacent block when three CPMVs are used for prediction of the spatially adjacent block and deriving a fourth CPMV of the spatial merge candidate from the first CPMV, the second CPMV and the third CPMV of the spatial merge candidate.

According to one embodiment, the deriving the fourth CPMV of the spatial merge candidate may comprise determining a prediction value of the fourth CPMV from the first CPMV, the second CPMV and the third CPMV of the spatial merge candidate, determining a difference value of the fourth CPMV, and deriving the fourth CPMV from the prediction block and the difference value of the fourth CPMV.

According to one embodiment, the determining the spatial merge candidate of the current block may comprise determining a first CPMV and a second CPMV of the spatial merge candidate from two CPMVs of the spatially adjacent block when two CPMVs are used for prediction of the spatially adjacent block and deriving a third CPMV and a fourth CPMV of the spatial merge candidate from the first CPMV and the second CPMV of the spatial merge candidate.

According to one embodiment, the deriving the third CPMV and the fourth CPMV of the spatial merge candidate may comprise determining prediction values of the third CPMV and the fourth CPMV from the first CPMV and the second CPMV of the spatial merge candidate, determining a difference value of the third CPMV and a difference value of the fourth CPMV, and deriving the third CPMV from the prediction value and the difference value of the third CPMV and deriving the fourth CPMV from the prediction value and the difference value of the fourth CPMV.

According to one embodiment, the determining the merge candidate list of the current block may comprise extracting a plurality of motion vectors from the spatially adjacent block and the temporally corresponding block of the current block and determining a combined merge candidate by combining the plurality of motion vectors.

According to one embodiment, the extracting the plurality of motion vectors may comprise deriving a first CPMV, a second CPMV and a third CPMV from a plurality of spatially adjacent blocks of the current block and deriving a fourth CPMV from a temporally corresponding block corresponding to a center position or a lower right position of the current block.

According to one embodiment, the extracting the plurality of motion vectors may comprise deriving a first CPMV, a second CPMV and a third CPMV from a plurality of spatially adjacent blocks and temporally corresponding blocks of the current block and deriving a fourth CPMV from the first CPMV, the second CPMV and the third CPMV.

According to one embodiment, the deriving the fourth CPMV may comprise determining a prediction block of the fourth CPMV from the first CPMV, the second CPMV and the third CPMV, determining a difference value of the fourth CPMV, and deriving the fourth CPMV based on the prediction value and the difference value of the fourth CPMV.

According to one embodiment, the determining the fourth CPMVs of the current block may comprise determining an MVP candidate list including at least one of a spatial MVP candidate, a temporal MVP block or a combined MVP candidate of the current block when a prediction mode of the current block is a motion vector prediction (MVP) mode and determining the four CPMVs of the current block according to an MVP candidate selected from the MVP candidate list of the current block.

According to one embodiment, the determining the MVP candidate list of the current block may comprise determining a spatial MVP candidate of the current block from a CPMV of a spatially adjacent block of the current block when the spatially adjacent block of the current block is predicted by an affine model and determining a temporal MVP candidate of the current block from a CPMV of a temporally corresponding block of the current block when the temporally corresponding block of the current block is predicted by an affine model.

According to one embodiment, the determining the spatial MVP candidate of the current block may comprise determining a first control point motion vector predictor (CPMVP), a second CPMVP and a third CPMVP of the spatial MVP candidate from three CPMVs of the spatially adjacent block when three CPMVs are used for prediction of the spatially adjacent block, and deriving a fourth CPMVP of the spatial MVP candidate from the first CPMVP, the second CPMVP and the third CPMVP of the spatial MVP candidate.

According to one embodiment, the determining the spatial MVP candidate of the current block may comprise determining a first CPMVP and a second CPMVP of the spatial MVP candidate from three CPMVs of the spatially adjacent block when two CPMVs are used for prediction of the spatially adjacent block and deriving a third CPMVP and a fourth CPMVP of the spatial MVP candidate from the first CPMVP and the second CPMVP of the spatial MVP candidate.

According to one embodiment, the determining the MVP candidate list of the current block may comprise extracting a plurality of motion vectors from a spatially adjacent block and a temporally corresponding block of the current block and determining a combined MVP candidate by combining the plurality of motion vectors.

According to one embodiment, the extracting the plurality of motion vectors may comprise deriving a first CPMVP, a second CPMVP and a third CPMVP from a plurality of spatially adjacent blocks of the current block and deriving a fourth CPMVP from a temporally corresponding block corresponding to a center position or a lower right position of the current block.

According to one embodiment, the extracting the plurality of motion vectors may comprise deriving a first CPMVP, a second CPMVP and a third CPMVP from a plurality of spatially adjacent blocks of the current block and deriving a fourth CPMVP from the first CPMVP, the second CPMVP and the third CPMVP.

In the present disclosure, provided is a video encoding method comprising determining that a current block is predicted by an affine model, determining four CPMVs of the current block, and encoding the four CPMVs and predicting the current block according to the four CPMVs.

According to one embodiment, whether a prediction mode of the current block is a merge mode or an MVP mode may be determined.

According to one embodiment, if the prediction mode of the current block is a merge mode, a merge candidate list including at least one of a spatial merge candidate, a temporal merge candidate, or a combined merge candidate of the current block may be determined. According to one embodiment, the merge candidate list of the current block may be determined according to the embodiment discussed in the decoding method of one embodiment of the present disclosure.

According to one embodiment, information indicating a merge candidate in the merge candidate list of the current block may be encoded. In addition, a difference value of the fourth CPMV for determining the fourth CPMV of the merge candidate applied to the current block may be encoded. In addition, according to an embodiment, a difference value of the third CPMV for determining the third CPMV of the merge candidate applied to the current block may be further encoded.

According to one embodiment, when the prediction mode of the current block is an MVP mode, an MVP candidate list including at least one of a spatial MVP candidate, a temporal MVP block, or a combined MVP candidate of the current block may be determined. According to one embodiment, the MVP candidate list of the current block may be determined according to the embodiment discussed in the decoding method of one embodiment of the present disclosure.

According to one embodiment, information indicating an MVP candidate from the MVP candidate list of the current block may be encoded. In addition, four difference values indicating a difference between the four CPMVs applied to the current block and the four CPMVPs of the MVP candidates may be encoded.

In the present disclosure, provided is a data transmission method of transmitting image data comprising generating a bitstream by encoding image data according to an image encoding method according to the embodiment of the present disclosure and transmitting the generated bitstream.

In the present disclosure, provided is a computer-readable recording medium that stores a bitstream generated by the image encoding method according to the embodiment of the present disclosure.

### Advantageous Effects

According to the present invention, it is possible to provide an image encoding/decoding method and apparatus that performs inter prediction according to affine transform.

In addition, according to the present invention, it is possible to provide a method and apparatus for transmitting or storing a bitstream generated by the image encoding method/apparatus according to the present invention.

In addition, according to the present invention, it is possible to provide a computer-readable recording medium that stores a bitstream generated by the image encoding method/apparatus according to the present invention.

In addition, image data can be efficiently encoded and decoded by the image encoding method/apparatus according to the present invention.

### DESCRIPTION OF DRAWINGS

FIG. 1 is a schematic diagram illustrating the configuration of an image encoding apparatus.

FIG. 2 is an exemplary diagram illustrating an embodiment of a prediction unit of an image encoding apparatus.

FIG. 3 illustrates a block to which a 4-parameter affine motion model is applied.

FIG. 4 illustrates a block to which a 6-parameter affine motion model is applied.

FIG. 5 illustrates a block from which a fourth CPMV, MV₃, is additionally derived in a 6-parameter affine motion model.

FIG. 6 illustrates pixel locations referenced to generate a merge candidate list in a current block.

FIG. 7 illustrates a spatial merge candidate derived from a left adjacent block.

FIG. 8 illustrates a spatial merge candidate derived from an upper adjacent block.

FIG. 9 illustrates a flowchart of a video decoding method of the present invention.

FIG. 10 illustrates a flowchart of a video encoding method of the present invention.

FIG. 11 illustrates a method of deriving six CPMVs of two partitions of a current block from one adjacent block.

FIG. 12 illustrates a method of deriving six CPMVs of two partitions of a current block from two adjacent blocks.

FIG. 13 illustrates a first prediction block, a second prediction block, and a final prediction block obtained by summing them.

FIG. 14 illustrates an embodiment of a weight of each sample used in calculation of a final prediction block.

FIG. 15 illustrates an embodiment of applying a low-pass filter to samples at a partition boundary of a current block.

FIG. 16 illustrates an embodiment of applying a low-pass filter to samples at a partition boundary of a current block and samples adjacent to a current partition boundary.

### BEST MODE

In the present disclosure, provided is a video decoding method comprising determining that a current block is predicted by an affine model, determining four control point motion vectors (CPMVs) of the current block, and predicting the current block according to the four CPMVs.

### MODE FOR INVENTION

Hereinafter, embodiments of the present invention will be described in detail with reference to the drawings attached to this specification so that those skilled in the art can easily implement the present invention. However, the present invention may be implemented in various different forms and is not limited to the embodiments described herein. In addition, in the drawings, parts irrelevant to the description have been omitted to clearly explain the present invention, and similar parts have been designated with similar reference numerals throughout the specification.

Throughout this specification, when a part is said to be ‘connected’ to another part, this includes not only cases where they are directly connected, but also cases where they are electrically connected with another element in between.

Additionally, whenever a part is said to “include” a component throughout this specification, this does not mean that other components are excluded, but rather that other components may be included, unless specifically stated otherwise.

Additionally, while terms such as first, second, etc. may be used to describe various components, these components should not be limited by these terms. These terms are used solely to distinguish one component from another.

Additionally, in the embodiments of the apparatuses and methods described herein, some components of the apparatuses or some steps of the methods may be omitted. Furthermore, the order of some components of the apparatuses or some steps of the methods may be changed. Furthermore, other components or steps may be inserted into some components of the apparatuses or some steps of the methods.

Furthermore, some components or steps of the first embodiment of the present invention may be added to the second embodiment of the present invention, or may replace some components or steps of the second embodiment.

In addition, the components shown in the embodiments of the present invention are independently illustrated to represent different characteristic functions, and this does not mean that each component is composed of separate hardware or a single software component. That is, each component is described by listing each component for convenience of explanation, and at least two components among components may be combined to form a single component, or a single component may be divided into multiple components to perform a function. Such integrated and separate embodiments of each component are also included in the scope of the present invention as long as they do not deviate from the essence of the present invention.

First, the terms used in this application are briefly explained as follows.

The decoding apparatus (video decoding apparatus) described below may be an apparatus included in a server terminal such as a civilian security camera, a civilian security system, a military security camera, a military security system, a personal computer (PC), a laptop computer, a portable multimedia player (PMP), a wireless communication terminal, a smart phone, a TV application server, a service server, etc., and may refer to various apparatuses including user terminals such as various devices, communication devices such as a communication modem for communicating with a wired or wireless communication network, a memory for storing various programs and data for decoding a video or performing inter or intra prediction for decoding, and a microprocessor for executing a program for calculation and control.

In addition, an image encoded into a bitstream by an encoder may be transmitted to an image decoding apparatus through wired or wireless communication networks such as the Internet, a local area network, a wireless LAN, a WiBro network, a mobile communication network, etc. in real time or non-real time, or through various communication interfaces such as a cable or a universal serial bus (USB), and may be decoded, reconstructed into an image, and played back. Alternatively, the bitstream generated by the encoder may be stored in a memory. The memory may include both a volatile memory and a non-volatile memory. In this specification, the memory may be expressed as a recording medium that stores a bitstream.

Typically, a video may be composed of a series of pictures, and each picture may be divided into coding units such as blocks. In addition, a person having ordinary skill in the art to which the present embodiment pertains will understand that the term picture described below may be replaced with other terms having equivalent meanings, such as image, frame, etc. In addition, a person having ordinary skill in the art to which the present embodiment pertains will understand that the term coding unit may be replaced with other terms having equivalent meanings, such as unit block, block, etc.

Hereinafter, embodiments of the present invention will be described in more detail with reference to the attached drawings. In describing the present invention, duplicate descriptions of identical components will be omitted.

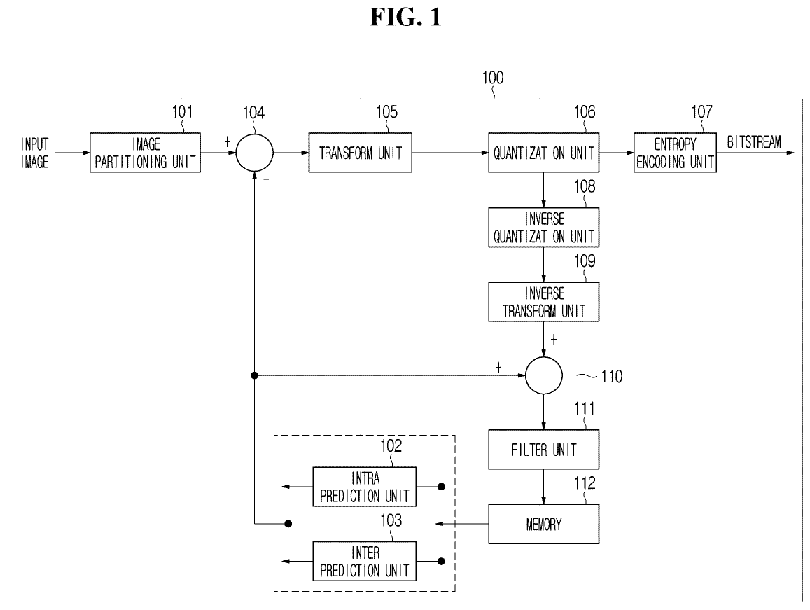

FIG. 1 is a schematic diagram illustrating the configuration of an image encoding apparatus.

The image encoding apparatus 100 may include an image partitioning unit 101, an intra prediction unit 102, an inter prediction unit 103, a subtractor 104, a transform unit 105, a quantization unit 106, an entropy encoding unit 107, an inverse quantization unit 108, an inverse transform unit 109, an adder 110, a filter unit 111, and a memory 112.

To select optimal information in each apparatus, RD-Cost (Rate Distortion Cost) may be compared. RD-Cost refers to a cost value calculated using distortion information between an original block and a reconstructed block and the amount of bits generated during prediction mode transmission. At this time, SAD (Sum of Absolute Difference), SATD (Sum of Absolute Transformed Difference), SSE (Sum of Square for Error) may also be used to calculate the cost value.

Components shown in FIG. 1 are independently shown to indicate different characteristic functions in the image encoding apparatus, and do not mean that each component is composed of separate hardware or a single software configuration unit. That is, each component is listed and included as a separate component for convenience of explanation, and at least two of components may be combined to form a single component, or one component may be divided into multiple components to perform a function, and such integrated and separate embodiments of each component are also included in the scope of the present invention as long as they do not deviate from the essence of the present invention.

In addition, some components may not be essential components that perform essential functions of the present invention, but may be optional components merely for improving performance. The present invention may be implemented by including only components essential to implementing the essence of the present invention, excluding components solely used for improving performance, and a structure that includes only essential components, excluding optional components solely used for improving performance, is also included in the scope of the present invention.

The image partitioning unit 100 may partition an input image into at least one block. At this time, the input image may have various shapes and sizes such as pictures, slices, tiles, and segments. The block may mean a coding unit (CU), a prediction unit (PU), or a transform unit (TU). Partitioning may be performed based on at least one of a quadtree, a binary tree, or a ternary tree. The quadtree is a method of dividing a parent block into four child blocks whose width and height are half that of the parent block. The binary tree is a method of dividing a parent block into two child blocks whose width or height is half that of the parent block. The ternary tree is a method of dividing a parent block into three child blocks based on either the width or the height. Through partitioning based on the above-described binary tree and ternary tree, the block may have a shape not only of a square but also of a non-square shape.

The prediction units 102 and 103 may include an inter prediction unit 103 that performs inter prediction and an intra prediction unit 102 that performs intra prediction. It may be determined whether to use inter prediction or intra prediction for a prediction unit, and specific information (e.g., intra prediction mode, motion vector, reference picture, etc.) according to each prediction method may be determined. At this time, a processing unit where the prediction is performed and a processing unit where a prediction method and specific contents are determined may be different. For example, the prediction method and prediction mode may be determined in a prediction unit, and prediction may be performed in a transform unit.

A residual value (residual block) between the generated prediction block and the original block may be input to the transform unit 105. In addition, the prediction mode information, motion vector information, etc. used for prediction may be encoded together with the residual value by the entropy encoding unit 107 and transmitted to a decoder. When a specific encoding mode is used, it is also possible to encode the original block as is and transmit it to the decoding unit without generating the prediction block through the prediction units 102 and 103.

The intra prediction unit 102 may generate a prediction block based on reference pixel information around a current block, which is pixel information within a current picture. If the prediction mode of the neighboring blocks of the current block on which intra prediction is to be performed is inter prediction, reference pixels included in the neighboring blocks to which inter prediction is applied may be replaced with reference pixels within other neighboring blocks to which intra prediction is applied. That is, if the reference pixels are not available, unavailable reference pixel information may be used by replacing it with at least one reference pixel among the available reference pixels.

In intra prediction, the prediction mode may have a directional prediction mode that uses reference pixel information according to the prediction direction, and a non-directional mode that does not use directional information. A mode for predicting luma information and a mode for predicting chroma information may be different. To predict chroma information, intra prediction mode information used for predicting luma information or the predicted luma signal information may be utilized.

The intra prediction unit 102 may include an Adaptive Intra Smoothing (AIS) filter, a reference pixel interpolation unit, and a DC filter. The AIS filter is a filter that filters the reference pixels of the current block and may adaptively determine whether to apply the filter depending on the prediction mode of the current prediction unit. If the prediction mode of the current block is a mode that does not perform AIS filtering, the AIS filter may not be applied.

The reference pixel interpolation unit of the intra prediction unit 102 may interpolate the reference pixel to generate a reference pixel at a fractional unit position when the intra prediction mode of the prediction unit is a mode that performs intra prediction based on the pixel value obtained by interpolating the reference pixel. When the prediction mode of the current prediction unit is a prediction mode that generates a prediction block without interpolating the reference pixel, the reference pixel may not be interpolated. The DC filter may generate a prediction block through filtering when the prediction mode of the current block is a DC mode.

The inter prediction unit 103 generates a prediction block using the previously reconstructed reference image and motion information stored in the memory 112. The motion information may include, for example, a motion vector, a reference picture index, a list 1 prediction flag, a list 0 prediction flag, etc.

A residual block including residual value information, which is a difference value between the prediction unit generated in the prediction units 102 and 103 and the prediction unit and the original block, may be generated. The generated residual block may be input to the transform unit 105 and transformed.

The inter prediction unit 103 may derive a prediction block based on information on at least one picture among the previous picture or the next picture of the current picture. In addition, the prediction block of the current block may also be derived based on information on a portion of the current picture in which encoding has been completed. The inter prediction unit 103 according to one embodiment of the present invention may include a reference picture interpolation unit, a motion prediction unit, and a motion compensation unit.

The reference picture interpolation unit may receive reference picture information from the memory 112 and generate pixel information less than an integer pixel from the reference picture. In the case of luma pixels, a DCT-based 8-tap interpolation filter with different filter coefficients may be used to generate pixel information less than an integer pixel in units of ¼ pixels. In the case of a chroma signal, a DCT-based 4-tap interpolation filter with different filter coefficients may be used to generate pixel information less than an integer pixel in units of ⅛ pixels.

The motion prediction unit may perform motion prediction based on the reference picture interpolated by the reference picture interpolation unit. Various methods such as FBMA (Full search-based Block Matching Algorithm), TSS (Three Step Search), and NTS (New Three-Step Search Algorithm) may be used as a method of calculating a motion vector. The motion vector may have a motion vector value in units of ½ or ¼ pixels based on the interpolated pixel. The motion prediction unit may predict the prediction block of the current block by using different motion prediction methods. Various methods such as a skip method, a merge method, and an advanced motion vector prediction (AMVP) method may be used as the motion prediction method.

The subtractor 104 subtracts a block to be currently encoded and the prediction block generated from the intra prediction unit 102 or inter prediction unit 103 to generate a residual block of the current block.

The transform unit 105 may transform the residual block including the residual data using a transform method such as DCT, DST, KLT (Karhunen Loeve Transform), etc. At this time, the transform method may be determined based on the intra prediction mode of the prediction unit used to generate the residual block. For example, depending on the intra prediction mode, DCT may be used in the horizontal direction and DST may be used in the vertical direction. Alternatively, different transform techniques may be used in the horizontal and vertical directions depending on the aspect ratio, size, etc. of the current block.

The quantization unit 106 may quantize the values transformed into the frequency domain by the transform unit 105. The quantization coefficients may vary depending on the block or the importance of the image. The values produced by the quantization unit 106 may be provided to the inverse quantization unit 108 and the entropy encoding unit 107.

The transform unit 105 and/or the quantization unit 106 may be optionally included in the image encoding apparatus 100. That is, the image encoding apparatus 100 may encode the residual block by performing at least one of transform or quantization on the residual data of the residual block, or skipping both transform and quantization. Even if neither transform nor quantization is performed in the image encoding apparatus 100, or neither transform nor quantization is performed, a block that is input to the entropy encoding unit 107 is typically referred to as a transform block.

The entropy encoding unit 107 entropy encodes the input data. Entropy encoding may use various encoding methods, such as Exponential Golomb, Context-Adaptive Variable Length Coding (CAVLC), and Context-Adaptive Binary Arithmetic Coding (CABAC).

The entropy encoding unit 107 may encode various information such as coefficient information of the transform block, block type information, prediction mode information, partitioning unit information, prediction unit information, transmission unit information, motion vector information, reference frame information, block interpolation information, and filtering information. The coefficients of the transform block may be encoded in units of sub-blocks within the transform block.

For encoding of the coefficients of the transform block, various syntax elements can be encoded, such as Last_sig, a syntax element indicating the position of the first non-zero coefficient in reverse scan order, Coded_sub_blk flag, a flag indicating whether there is at least one non-zero coefficient in the subblock, Sig_coeff flag, a flag indicating whether it is a non-zero coefficient, Abs_greater1_flag, a flag indicating whether the absolute value of the coefficient is greater than 1, Abs_greater2_flag, a flag indicating whether the absolute value of the coefficient is greater than 2, and Sign_flag, a flag indicating the sign of the coefficient. The remaining values of coefficients that are not encoded by the syntax elements alone may be encoded through the syntax element remaining_coeff.

The inverse quantization unit 108 and the inverse transform unit 109 inversely quantize the values quantized in the quantization unit 106 and inversely transform the values transformed in the transform unit 105. The residual values generated in the inverse quantization unit 108 and the inverse transform unit 109 may be combined with the prediction units predicted through the motion estimation unit, motion compensation unit, and the intra prediction unit 102 included in the prediction units 102 and 103 to generate a reconstructed block. The adder 110 adds the prediction blocks generated in the prediction units 102 and 103 and the residual blocks generated through the inverse transform unit 109 to generate a reconstructed block.

The filter unit 111 may include at least one of a deblocking filter, an offset correction unit, or an ALF (Adaptive Loop Filter).

A deblocking filter may remove block distortion caused by boundaries between blocks in a reconstructed picture. In order to determine whether to perform deblocking, it is possible to determine whether to apply a deblocking filter to the current block based on the pixels included in several columns or rows included in the block. When applying a deblocking filter to a block, a strong filter or a weak filter may be applied depending on the required deblocking filtering strength. In addition, when applying a deblocking filter, horizontal filtering and vertical filtering may be processed in parallel when performing vertical filtering and horizontal filtering.

The offset correction unit may correct the offset from the original image on a pixel-by-pixel basis for the image on which deblocking has been performed. To perform offset correction for a specific picture, a method of dividing pixels included in the image into a certain number of areas, determining an area in which the offset will be performed and applying the offset to the area or a method of applying the offset by considering edge information of each pixel may be used.

Adaptive Loop Filtering (ALF) may be performed based on the value obtained by a comparison between the filtered reconstructed image and the original image. After dividing the pixels included in the image into a predetermined group, a filter to be applied to the group is determined, and filtering may be performed differentially for each group. In information related to whether to apply ALF, luma signal may be transmitted for each coding unit (CU), and the shape and filter coefficients of the ALF filter to be applied may vary depending on each block. In addition, the same shape (fixed shape) of the ALF filter may be applied regardless of the characteristics of the target block.

The memory 112 may store the reconstructed block or picture calculated through the filter unit 111, and the stored reconstructed block or picture may be provided to the prediction units 102 and 103 when performing inter prediction.

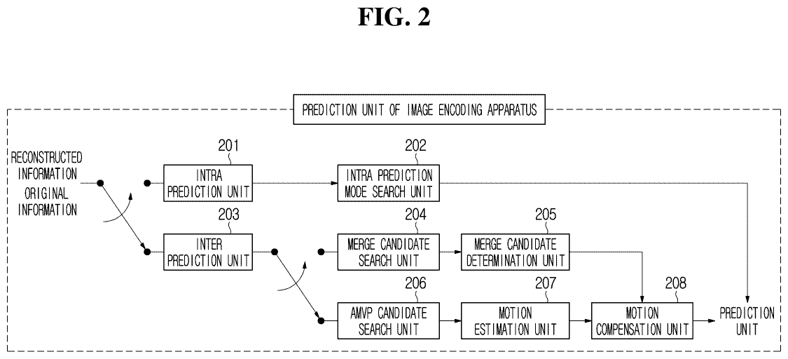

FIG. 2 is an exemplary diagram illustrating an embodiment of a prediction unit of an image encoding apparatus.

If a prediction mode of a current block is an intra prediction mode, an intra prediction unit 201 may generate reference pixels by deriving reference pixels from the periphery of the current block and filtering the reference pixels. The reference pixels are determined using reconstructed pixels around the current block. If some reconstructed pixels are not available or there are no reconstructed pixels around the current block, an unavailable area may be padded with the available reference pixels or padded with a middle value among the range of values that the pixels may have. After all reference pixels are derived, the reference pixels may be filtered using an Adaptive Intra Smoothing (AIS) filter.

An intra prediction mode search unit 202 may determine one mode among M intra prediction modes, where M represents the total number of intra prediction modes. The intra prediction modes include a directional prediction mode and a non-directional prediction mode.

A prediction block is generated using the determined prediction mode and filtered reference pixels. The RD-Cost may be compared for each intra prediction mode to select the intra prediction mode with the lowest cost.

An inter prediction unit 203 may be divided into a merge candidate search unit 204 and an AMVP candidate search unit 206 depending on the method of deriving motion information. The merge candidate search unit 204 sets reference blocks that use inter prediction among the blocks reconstructed around the current block as merge candidates. Merge candidates are derived in the same way in the encoding/decoding apparatus, and the same number is used. The number of merge candidates is transmitted from the encoding apparatus to the decoding apparatus, or a predetermined number is used. If the predetermined number of merge candidates cannot be derived from the reference blocks reconstructed around the current block, the motion information of a block existing at the same position as the current block in a picture other than the current picture may be used as a merge candidate. Alternatively, the insufficient merge candidate may be derived by combining the motion information in the past direction and the motion information in the future direction based on the current picture. Alternatively, a block at the same position in another reference picture may be set as a merge candidate.

The AMVP candidate search unit 206 determines the motion information of the current block from a motion estimation unit 207. The motion estimation unit 207 finds the prediction block most similar to the current block from the reconstructed pictures.

When inter prediction is performed, the motion information of the current block is determined using one of the merge candidate search unit 204 and the AMVP candidate search unit (206), and motion compensation 208 generates a prediction block based on the determined motion information.

The present invention proposes a motion prediction/compensation technique based on a fractional pel-based affine motion model to improve inter prediction encoding according to motions such as zoom, rotation, and shear.

The proposed method for motion prediction/compensation based on an affine motion model is applicable to the inter prediction affine MVP mode and affine merge mode of an encoder/decoder.

In addition, the proposed method for motion prediction/compensation based on the affine motion model is performed in units of CU or sub-CU (sub-block) to improve encoding efficiency.

In addition, the block to which the proposed method for motion prediction/compensation based on the affine motion model is applied has a size of W×H. (W≥4, H≥4)

The affine motion model may be divided into a 4-parameter affine motion model and a 6-parameter affine motion model depending on the CPMV (Control Point Motion Vector) used. The 4-parameter affine motion model uses 4 parameters MV₀^{h}, MV₀^{Y}, MV₁^{h} and MV₁^{Y} obtained from 2 CPMVs. In addition, the 6-parameter affine motion model uses 6 parameters MV₀^{h}, MV₀^{Y}, MV₁^{h}, MV₁^{Y}, MV₂^{h} and MV₂^{Y} obtained from 3 CPMVs.

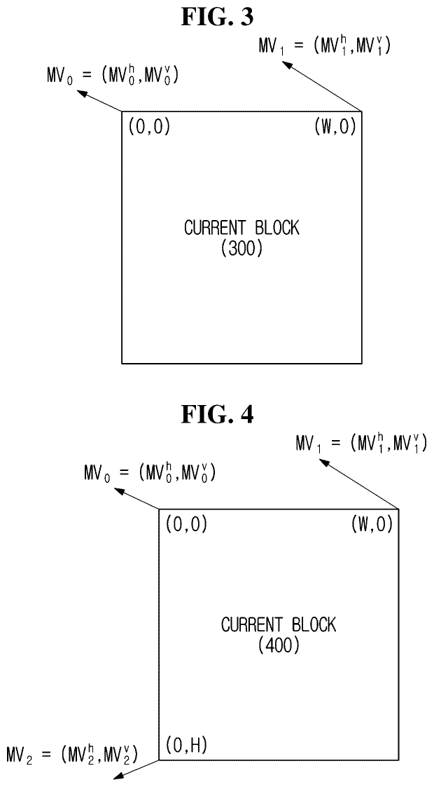

FIG. 3 illustrates a block to which a 4-parameter affine motion model is applied.

In a current block 300, two CPMVs MV₀ and MV₁ are determined according to a 4-parameter affine motion model. MV₀ is determined based on the (0,0) position, and MV₁ is determined based on the (W,0) position. Then, (MV₀^{h}, MV₀^{v}) is determined from MV₀, and (MV₁^{h}, MV₁^{v}) is determined from MV1. According to the affine model based on the four parameters, the pixels of the current block 300 may be inter-predicted.

Equations 1 to 5 below describe a method of calculating the motion vector of the current pixel according to the 4-parameter affine motion model. The 3×3 matrix in Equation 1 below represents affine transform. In addition, x and y represent the position of the current pixel, and x′ and y′ represent the positions of the reference pixels referenced by the current pixel.

$$[ \begin{matrix}{x}^{′} \\ {y}^{′} \\ 1\end{matrix} ] = [ \begin{matrix}a & c & e \\ b & d & f \\ 0 & 0 & 1\end{matrix} ] [ \begin{matrix}x \\ y \\ 1\end{matrix} ] \text{?} \begin{matrix}{x}^{′} = ax + cy + e \\ {y}^{′} = bx + dy + f\end{matrix} \qquad [ Equation 1 ]$$

Equation 2 below represents components (MV^{h}, MV^{v}) of a motion vector MV, which represents a displacement between (x, y) and (x′, y′).

$$\begin{matrix}{MV}^{h} = x - {x}^{′} \\ {MV}^{ν} = y - {y}^{′}\end{matrix} \text{?} \begin{matrix}{MV}^{h} = ( 1 - a ) x - cy \to e \\ {MV}^{v} = - bx + ( 1 - d ) y - f\end{matrix} \qquad [ Equation 2 ]$$

Equation 3 below represents two CPMVs, MV₀ and MV₁, applied to the 4-parameter affine motion model.

$${MV}_{0} = ( {MV}_{0}^{h} , {MV}_{0}^{v} ) , ( x , y ) = ( 0 , 0 ) \\ {MV}_{1} = ( {MV}_{1}^{h} , {MV}_{1}^{v} ) , ( x , y ) = ( W , 0 ) \qquad [ Equation 3 ]$$

Equation 4 below is a calculation formula that determines a, b, and e of Equation 2 according to Equations 2 and 3.

$$\begin{matrix}{MV}_{0}^{h} = - e , {MV}_{0}^{v} = - f \\ {MV}_{1}^{h} = ( 1 - a ) W \to e , {MV}_{1}^{v} = - bW - f\end{matrix} \\ \text{?} \begin{matrix}a = \frac{{MV}_{0}^{h} - {MV}_{1}^{h}}{W} + 1 , b = \frac{{MV}_{0}^{v} - {MV}_{1}^{v}}{W} \\ e = - {MV}_{0}^{h} , f = - {MV}_{0}^{v}\end{matrix} \qquad [ Equation 4 ]$$

Equation 5 below shows a calculation formula of the motion vector MV determined based on Equations 2 and 4.

$$\{ \begin{matrix}{MV}^{h} = \frac{{MV}_{1}^{h} - {MV}_{0}^{h}}{W} x + \frac{{MV}_{0}^{v} - {MV}_{1}^{ν}}{W} y + {MV}_{0}^{h} \\ {MV}^{v} = \frac{{MV}_{1}^{ν} - {MV}_{0}^{ν}}{W} x + \frac{{MV}_{1}^{h} - {MV}_{0}^{h}}{W} y + {MV}_{0}^{v}\end{matrix} \qquad [ Equation 5 ]$$

According to Equation 5, it can be seen that the zoom and rotation transform are applied in the inter prediction of the block according to the 4-parameter affine motion model.

FIG. 4 illustrates a block to which a 6-parameter affine motion model is applied.

In a current block 400, three CPMVs MV₀, MV₁ and MV₂ are determined according to a six-parameter affine motion model. MV₀ is determined based on the (0,0) position, MV₁ is determined based on the (W,0) position, and MV₂ is determined based on the (0,H) position. Then, (MV₀^{h}, MV₀^{v}) is determined from MV₀, (MV₁^{h}, MV₁^{Y}) is determined from MV₁, and (MV₂^{h}, MV₂^{v}) is determined from MV₂. According to the affine model according to the six parameters, the pixels of the current block 400 may be inter-predicted.

Equations 6 to 10 below describe a method of calculating a motion vector of a current pixel according to a 6-parameter affine motion model. A matrix with a size of 3×3 in Equation 6 below represents affine transform. In addition, x and y represent the position of the current pixel, and x′ and y′ represent the positions of reference pixels referenced by the current pixel.

$$[ \begin{matrix}{x}^{′} \\ {y}^{′} \\ 1\end{matrix} ] = [ \begin{matrix}a & c & e \\ b & d & f \\ 0 & 0 & 1\end{matrix} ] [ \begin{matrix}x \\ y \\ 1\end{matrix} ] \text{?} \begin{matrix}{x}^{′} = ax + cy + e \\ {y}^{′} = bx + dy + f\end{matrix} \qquad [ Equation 6 ]$$

Equation 7 below represents components (MV^{h}, MV^{v}) of a motion vector MV, which represents a displacement between (x, y) and (x′, y′).

$$\begin{matrix}{MV}^{h} = x - {x}^{′} \\ {MV}^{ν} = y - {y}^{′}\end{matrix} \text{?} \begin{matrix}{MV}^{h} = ( 1 - a ) x - cy - e \\ {MV}^{v} = - bx + ( 1 - d ) y - f\end{matrix} \qquad [ Equation 7 ]$$

Equation 8 below represents three CPMVs, MV₀, MV₁ and MV₂, applied to the 6-parameter affine motion model.

$${MV}_{0} = ( {MV}_{0}^{h} , {MV}_{0}^{ν} ) , ( x , y ) = ( 0 , 0 ) \\ {MV}_{1} = ( {MV}_{1}^{h} , {MV}_{1}^{v} ) , ( x , y ) = ( W , 0 ) \\ {MV}_{2} = ( {MV}_{2}^{h} , {MV}_{2}^{v} ) , ( x , y ) = ( 0 , H ) \qquad [ Equation 8 ]$$

Equation 9 below is a calculation formula that determines a, b, c, d, e, and f of Equation 2 according to Equations 7 and 8.

$$\begin{matrix}{MV}_{0}^{h} = - e , {MV}_{0}^{v} = - f \\ {MV}_{1}^{h} = ( 1 - a ) W - e , {MV}_{1}^{v} = - bW - f \\ {MV}_{2}^{h} = - cH - e , {MV}_{2}^{ν} = ( 1 - d ) H - f\end{matrix} \\ \text{?} \begin{matrix}a = \frac{{MV}_{0}^{h} - {MV}_{1}^{h}}{W} + 1 , b = \frac{{MV}_{0}^{v} - {MV}_{1}^{ν}}{W} \\ c = \frac{{MV}_{0}^{h} - {MV}_{2}^{h}}{W} , d = \frac{{MV}_{0}^{ν} - {MV}_{2}^{ν}}{H} + 1 \\ e = - {MV}_{0}^{h} , f = - {MV}_{0}^{v}\end{matrix} \qquad [ Equation 9 ]$$

Equation 10 below shows a calculation formula of a motion vector MV determined based on Equations 7 and 9.

$$\{ \begin{matrix}{MV}^{h} = \frac{{MV}_{1}^{h} - {MV}_{0}^{h}}{W} x + \frac{{MV}_{2}^{h} - {MV}_{0}^{h}}{H} y + {MV}_{0}^{h} \\ {MV}^{v} = \frac{{MV}_{1}^{v} - {MV}_{0}^{v}}{W} x + \frac{{MV}_{2}^{ν} - {MV}_{0}^{v}}{H} y + {MV}_{0}^{v}\end{matrix} \qquad [ Equation 10 ]$$

According to Equation 10, it can be seen that the zoom, rotation and shear transform are applied in the inter prediction of the block according to the 6-parameter affine motion model.

FIG. 5 illustrates a block from which a fourth CPMV, MV₃, is additionally derived in a 6-parameter affine motion model.

For a current block 500, a fourth CPMV MV₃ is additionally determined. In addition, (MV₃^{h}, MV₃^{Y}) is determined from MV₃. MV₃ of the current block 500 may be derived from MV₀, MV₁, and MV₂. Specifically, MV₃ may be derived from MV₀, MV₁, and MV₂ according to the corresponding positions (W, H) of MV₃.

In the video encoding process, MV₃ may be determined by adjusting MV₃′ derived from MV₀, MV₁, and MV₂. Here, MV₃′ may be calculated as “MV1+MV2−MV0”. Then, among the multiple motion vectors adjacent to MV₃′, the motion vector that shows the most similar prediction result to the current block 500 may be determined as MV₃.

The plurality of motion vectors are included in a predetermined integer pixel range 510 from MV₃′. The predetermined integer pixel range 510 may be set from −N to +N for the x component and the y component. Here, N is a positive integer. N may be set to 1, 2, 3, or a larger value. When N is large, the accuracy of MV₃ increases, but the amount of computation of the encoder may increase. Therefore, the value of N may be determined by considering the computational capability of the encoder.

In addition, the plurality of motion vectors may be determined in units of a predetermined fractional pixel. The predetermined fractional pixel unit may be determined as ½, ¼, ⅛, 1/16, 1/32, etc. When the fractional pixel unit is small, the accuracy of MV₃ increases, but the amount of computation of the encoder may increase. Therefore, the fractional pixel unit of MV₃ may be determined by considering the computational capability of the encoder.

Information about MV₃ may be encoded in the video encoding process. Affine inter prediction may be divided into Affine merge mode and Affine mvp (motion vector prediction) mode. According to the Affine merge mode, information related to inter prediction, such as CPMV and reference picture of adjacent blocks of the current block, is used for the current block. On the other hand, according to the Affine mvp mode, only the CPMV of adjacent blocks of the current block is used for the current block, and the MV difference value for modifying the CPMV of the adjacent block and information related to the reference picture are parsed from the bitstream and used. Hereinafter, image encoding and decoding methods according to the Affine merge mode and the Affine mvp mode will be described.

The prediction mode of a block predicted according to the Affine motion model may be determined as one of the Affine merge mode and the Affine mvp mode by a merge flag (merge_flag). In the encoding process, when the prediction mode of the block is the Affine merge mode, the merge flag may be determined to indicate 1. Conversely, when the prediction mode of the block is the Affine mvp mode, the merge flag may be determined to indicate 0. In some embodiments, the prediction mode corresponding to the symbol (0 or 1) indicated by the merge flag may be determined inversely. Conversely, in the decoding process, the prediction mode of the current block may be determined as one of the Affine merge mode and the Affine mvp mode according to the merge flag.

In the Affine merge mode, a merge candidate list is determined from the adjacent blocks of the current block. The maximum number of merge candidates is determined as N. For example, N may be determined as 5, 6, 7, 8, or a higher value. The merge candidate list may include a left merge candidate and an upper merge candidate. The left merge candidate includes motion information used for the affine inter prediction of the left adjacent block. In addition, the upper merge candidate includes motion information used for the affine inter prediction of the upper adjacent block.

The merge candidate list may include a temporal merge candidate. The temporal merge candidate includes motion information used for Affine inter prediction of a temporally corresponding block located at a position corresponding to the current block. The temporally corresponding block is included in one of the reference pictures referenced by the current picture.

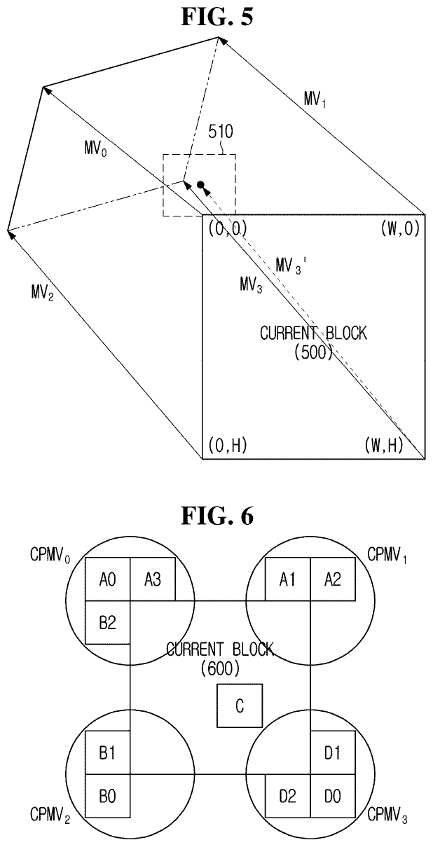

FIG. 6 illustrates locations of blocks referenced to generate a merge candidate list in a current block.

Currently, a block 600 has A0, A1, A2, and A3 on the upper side, and B0, B1, and B2 on the left side. Therefore, when determining a spatial merge candidate, blocks located at A0, A1, A2, A3, B0, B1, and B2 may be referenced. The current block 600 has D0 on the lower right side, and C in the center. When determining a temporal merge candidate, a block corresponding to one of C, D0, D1, and D2 may be referenced.

Only three CPMVs in a block referenced in a spatial merge candidate or a temporal merge candidate may be used for inter prediction. If four CPMVs are used in the current block, the fourth CPMV may be derived using three CPMVs. For example, if only three CPMVs are used for the prediction of an adjacent block, the CPMVs MV₀, MV₁ and MV₂ of the current block may be derived from the three CPMVs of the adjacent block. In addition, MV₃′ may be derived according to the affine model according to the CPMVs MV₀, MV₁ and MV₂ of the current block. However, since MV₃′ is derived from the affine model of MV₀, MV₁ and MV₂, the prediction results are the same between the affine model according to MV₀, MV₁ and MV₂ and the affine model according to MV₀, MV₁, MV₂ and MV₃′. Therefore, in the encoding process, the MV with the highest prediction accuracy among the MVs within a predetermined range adjacent to MV₃′ may be searched for, as described in FIG. 5. If an MV with a higher prediction accuracy than MV₃′ is searched, that MV may be determined as MV₃. Conversely, if no MV with a higher prediction accuracy than MV₃′ is searched, MV₃′ may be determined as MV₃. Alternatively, if MV₃′ is the same as MV₃, there is no reason to use four CPMVs, so only MV₀, MV₁ and MV₂ may be set to be used.

In the encoding process, when four CPMVs are used, a difference value representing a difference between MV₃′ and MV₃ may be encoded. In addition, by decoding the difference value in the decoding process, MV₃ can be derived from MV₃′.

If three CPMVs are used in the encoding process (MV₃′ and MV₃ are the same, so there is no benefit in using four CPMVs), the difference value representing the difference between MV₃′ and MV₃ is not encoded. In addition, by decoding the difference value in the decoding process, the current block may be predicted using only MV₀, MV₁ and MV₂.

Only two CPMVs in a block referenced in a spatial merge candidate or a temporal merge candidate may be used for inter prediction. If three or more CPMVs are used in the current block, the third CPMV may be derived using two CPMVs. Additionally, if four CPMVs are used in the current block, the third and fourth CPMVs may be derived using the two CPMVs.

For example, if only two CPMVs are used for predicting the adjacent block, first, the CPMVs MV₀ and MV₁ of the current block may be derived from the two CPMVs of the adjacent block. Then, MV₂′ may be derived according to the affine model according to MV₀ and MV₁, which are the CPMVs of the current block. However, since MV₂′ is derived from the affine model of MV₀ and MV₁, the prediction results are the same between the affine model according to MV₀ and MV₁ and the affine model according to MV₀, MV₁, and MV₂′. Therefore, in the encoding process, the MV with the highest prediction accuracy among the MVs within a predetermined range adjacent to MV₂′ may be searched. If an MV with a higher prediction accuracy than MV₂′ is searched, the MV may be determined as MV₂. Conversely, if no MV with a higher prediction accuracy than MV₂′ is searched, MV₂′ may be determined as MV₂. Alternatively, if MV₂′ is equal to MV₂, there is no reason to use three CPMVs, so only MV₀ and MV₁ may be set to be used.

If MV₂ is derived as above, MV₃ may be additionally derived. MV₃′ may be derived according to the affine model according to MV₀ and MV₁, which are already determined CPMVs. Alternatively, MV₃′ may be derived according to the affine model according to MV₀, MV₁ and MV₂, including the previously derived MV₂. In addition, an MV with the highest prediction accuracy among the MVs within a predetermined range adjacent to MV₃′ may be searched. If an MV with a higher prediction accuracy than MV₃′ is searched, that MV may be determined as MV₃. Conversely, if an MV with a higher prediction accuracy than MV₃′ is not searched, MV₃′ can be determined as MV₃. Alternatively, if MV₃′ is equal to MV₃, there is no reason to use four CPMVs, so only MV₀, MV₁ and MV₂ may be set to be used.

As above, even when two CPMVs are used for blocks corresponding to spatial merge candidates or temporal merge candidates of the current block, three or four CPMVs for affine prediction of the current block may be derived from the corresponding blocks. In addition, the difference values between MV₂′ and MV₂ and the difference values between MV₃′ and MV₃ are encoded in the encoding process, and the difference values may be decoded in the decoding process.

In conclusion, when referring to a spatial merge candidate or a temporal merge candidate in the Affine merge mode, even if the number of CPMVs of the reference block is 2 or 3, the current block may be predicted based on 4 CPMVs by additionally deriving CPMVs from the CPMV of the reference block.

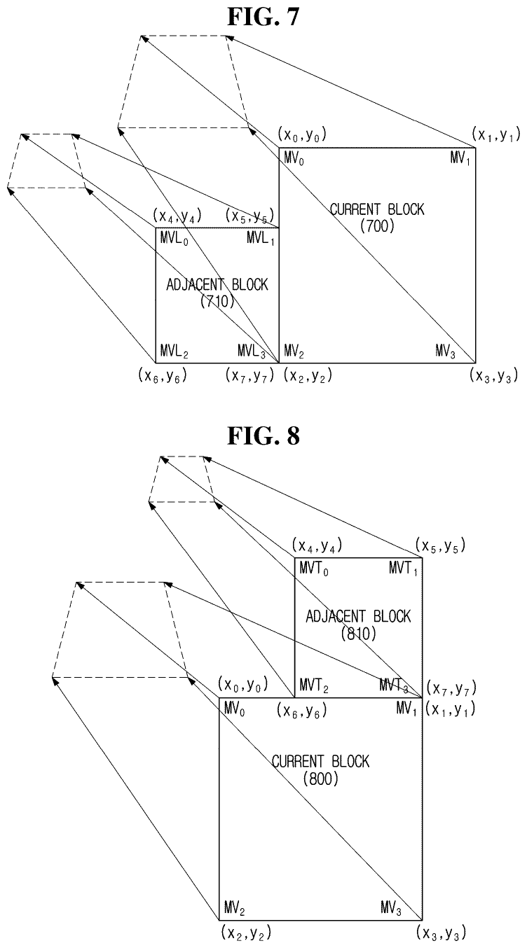

FIG. 7 illustrates a spatial merge candidate derived from a left adjacent block.

If a left adjacent block 710 is predicted according to the Affine model, the CPMV of a current block 700 is derived from the left adjacent block 710. Equation 11 below shows a method of determining MV₀, MV₁, MV₂, and MV₃, which are CPMVs used in the current block 700, by using MVL₀, MVL₁, MVL₂, and MVL₃, which are CPMVs used in the left adjacent block 710.

$${MV}_{0} = {MVL}_{1} + \frac{{y}_{5} - {y}_{0}}{{y}_{6} - {y}_{4}} ( {MVL}_{2} - {MVL}_{0} ) \\ {MV}_{1} = {MV}_{0} + \frac{{x}_{1} - {x}_{0}}{{x}_{5} - {x}_{4}} ( {MVL}_{1} - {MVL}_{0} ) \\ {MV}_{2} = {MV}_{0} + \frac{{y}_{2} - {y}_{0}}{{y}_{6} - {y}_{4}} ( {MVL}_{2} - {MVL}_{0} ) \\ {MV}_{3} = {MV}_{2} + \frac{{x}_{3} - {x}_{2}}{{x}_{7} - {x}_{6}} ( {MVL}_{3} - {MVL}_{2} ) \qquad [ Equation 11 ]$$

According to Equation 11, MV₀, MV₁, MV₂, and MV₃ are derived according to the respective corner coordinate values of the current block 700 and the left adjacent block 710. Therefore, the sizes of the current block 700 and the left adjacent block 710 may be considered in the derivation of MV₀, MV₁, MV₂, and MV₃.

Here, for the left adjacent block 710, if only MVL₀, MVL₁ and MVL₂ are used as CPMV, MV₀, MV₁ and MV₂ of the current block 700 are determined based on MVL₀, MVL₁, and MVL₂. And MV₃ of the current block 700 may be derived from MV₀, MV₁ and MV₂ of the current block 700 as described above.

In addition, for the left adjacent block 710, if only MVL₀ and MVL₁ are used as CPMV, MV₀ and MV₁ of the current block 700 are determined based on MVL₀, MVL₁, and MVL₂. In addition, MV₂ and MV₃ of the current block 700 may be derived from MV₀ and MV₁ of the current block 700 as described above.

FIG. 8 illustrates a spatial merge candidate derived from an upper adjacent block.

If an upper adjacent block 810 is predicted according to the Affine model, the CPMV of a current block 800 is derived from the upper adjacent block 810. Equation 12 below shows a method of determining the CPMVs MV₀, MV₁, MV₂ and MV₃ used in the current block 800 by using the CPMVs MVT₀, MVT₁, MVT₂ and MVT₃ used in the upper adjacent block 810.

$${MV}_{0} = {MVT}_{2} + \frac{{x}_{6} − {x}_{0}}{{x}_{5} − {x}_{4}} ( {MVT}_{1} − {MVT}_{0} ) \qquad [ Equation 12 ]$$

$${MV}_{1} = {MV}_{0} + \frac{{x}_{1} − {x}_{0}}{{x}_{5} − {x}_{4}} ( {MVT}_{1} − {MVT}_{0} )$$

$${MV}_{2} = {MV}_{0} + \frac{{y}_{2} − {y}_{0}}{{y}_{6} − {y}_{4}} ( {MVT}_{2} − {MVT}_{0} )$$

$${MV}_{3} = {MV}_{1} + \frac{{y}_{3} − {y}_{2}}{{y}_{7} − {y}_{5}} ( {MVT}_{3} − {MVT}_{1} )$$

According to Equation 12, MV₀, MV₁, MV₂, and MV₃ are derived based on the respective corner coordinate values of the current block 800 and the upper adjacent block 810. Therefore, the sizes of the current block 800 and the upper adjacent block 810 may be considered in the derivation of MV₀, MV₁, MV₂ and MV₃.

Here, for the upper adjacent block 810, if only MVT₀, MVT₁ and MVT₂ are used as CPMV, MV₀, MV₁, and MV₂ of the current block 800 are determined based on MVT₀, MVT₁ and MVT₂. In addition, MV₃ of the current block 800 may be derived from MV₀, MV₁ and MV₂ of the current block 800 as described above.

In addition, for the upper adjacent block 810, if only MVT₀ and MVT₁ are used as CPMV, MV₀ and MV₁ of the current block 800 are determined based on MVT₀, MVT₁ and MVT₂. In addition, MV₂ and MV₃ of the current block 800 may be derived from MV₀ and MV₁ of the current block 800 as described above.

The merge candidate list may include a combined merge candidate. The combined merge candidate of the current block may be determined by determining the MV (motion vector) of the adjacent block of the current block as the CPMV of the current block and combining the CPMV of the current block.

For example, the MVs of the upper left adjacent block, lower left adjacent block, and upper right adjacent block of the current block may be used as the CPMV of the current block. The upper left adjacent block may be determined as a block corresponding to one of A0, A3, and B2 of FIG. 6. The lower left adjacent block may be determined as a block corresponding to one of B0 and B1 of FIG. 6. The upper right adjacent block may be determined as a block corresponding to one of A1 and A2 of FIG. 6.

In addition, the MV of the temporally corresponding block corresponding to the center position or the lower right position of the current block may be used as the CPMV of the current block. The center position may be C. In addition, the lower right position may be selected from one of D0, D1, and D2. The temporally corresponding block is included in one of the reference pictures referred to by the current picture. Therefore, according to an embodiment, the combined merge candidate of the current block may be determined by combining the MV₀ of the upper left adjacent block of the current block, the MV₁ of the lower left adjacent block, the MV₂ of the upper right adjacent block, and the MV₃ of the temporally corresponding block.

Specifically, in a 6-parameter affine motion model, three MVs among MV₀, MV₁, MV₂ and MV₃ of the current block may be used as the CPMV of the current block. The combination of MVs used for the combined merge candidates of the current block may be selected from [MV₀, MV₁, MV₂], [MV₀, MV₁, MV₃], [MV₀, MV₂, MV₃], and [MV₁, MV₂, MV₃].

Additionally, in a 4-parameter affine motion model, two MVs among MV₀, MV₁, MV₂ and MV₃ of the current block may be used as the CPMV of the current block. The combination of MVs used for the current block's combined merge candidate may be selected from [MV₀, MV₁], [MV₀, MV₂], [MV₀, MV], [MV₁, MV₂], [MV₁, MV₃], and [MV₂, MV₃].

If MV₃ is additionally used in the 6-parameter affine motion model, that is, if 4 CPMVs are used, MV₀, MV₁, MV₂ and MV₃ may all be used as CPMVs.

According to one embodiment, when generating a combined merge candidate including four CPMVs, a process of deriving one CPMV from three CPMVs determined from adjacent blocks may be performed. For example, MV₃ may be determined from MV₀, MV₁ and MV₂ obtained from the upper left adjacent block, the lower left adjacent block, and the upper right adjacent block of the current block. At this time, in the encoding process, MV₃′ may be determined from MV₀, MV₁ and MV₂, and the MV with the highest prediction accuracy among the MVs within a predetermined range adjacent to MV₃′ may be determined as MV₃. Conversely, in the decoding process, MV₃′ may be determined from MV₀, MV₁, and MV₂, and MV₃ may be determined by adding a difference value between MV₃′ and MV₃ obtained from the bitstream to MV₃′. In this case, MV₃ may not be derived from the temporally corresponding block.

According to one embodiment, if a part of a reference block referenced by a combined merge candidate does not exist or is not intra-predicted, an MV cannot be derived from the reference block. Therefore, an MV corresponding to an unavailable block may be derived from an MV of an available block based on the above-mentioned method. For example, when generating a combined merge candidate including four CPMVs, if MV₂ is not available among MV₀, MV₁, MV₂ and MV₃ corresponding to the upper left adjacent block, lower left adjacent block, upper right adjacent block, and temporally corresponding block of the current block, MV₂ may be derived from MV₀, MV₁, and MV₃. At this time, in the encoding process, MV₂′ may be determined from MV₀, MV₁ and MV₃, and an MV with the highest prediction accuracy among the MVs within a predetermined range adjacent to MV₂′ may be determined as MV₂. Conversely, in the decoding process, MV₂′ may be determined from MV₀, MV₁ and MV₃, and MV₂ may be determined by adding the difference value between MV₂′ and MV₂ obtained from the bitstream to MV₂′.

According to one embodiment, when generating a combined merge candidate including four CPMVs, the combined merge candidate may be generated from three CPMVs (MV₀, MV₁, MV₂) derived from spatially adjacent blocks, one CPMV (MV₃) derived from the three CPMVs, and one CPMV (MV₄) derived from a temporally corresponding block. In determining MV₃, in the encoding process, MV₃′ may be determined from MV₀, MV₁ and MV₂, and an MV with the highest prediction accuracy among MVs within a predetermined range adjacent to MV₃′ may be determined as MV₃. Conversely, in the decoding process, MV₃′ may be determined from MV₀, MV₁ and MV₂, and a difference value between MV₃′ and MV₃ obtained from a bitstream may be added to MV₃′, thereby determining MV₃. At this time, MV₃′ may be derived based on one of D0, D1, and D2, which are the lower right positions of FIG. 6.

The combination of MVs used for the combined merge candidate of the current block may be selected from [MV₀, MV₁, MV₂, MV₃], [MV₀, MV₁, MV₂, MV₄], [MV₀, MV₁, MV₃, MV₄], [MV₀, MV₂, MV₃, MV₄], and [MV₁, MV₂, MV₃, MV₄].

In some cases, the merge candidate list may not be completed because some of the spatial merge candidates, temporal merge candidates, and combined merge codes are not available. In this case, the merge candidate list may be completed by including a zero merge candidate composed of a zero vector in the merge candidate list.

When the Affine MVP mode is selected, an MVP list is determined from the adjacent blocks of the current block. The maximum number of MVP candidates is determined as M. For example, M may be determined as 2, 3, 4, 5, or more. The MVP candidate list may include a left MVP candidate and an upper MVP candidate. The left MVP candidate includes an MV derived from the CPMV used for the affine inter prediction of the left adjacent block. In addition, the upper MVP candidate includes an MV derived from the CPMV used for the affine inter prediction of the upper adjacent block.

In addition, the MVP candidate list may include a temporal MVP candidate extracted from a temporally corresponding block of the current block. The temporal MVP candidate includes an MV derived from a CPMV used for affine inter prediction of the temporally corresponding block. The temporally corresponding block is included in one of the reference pictures referenced by the current picture. In addition, the position of the temporally corresponding block may correspond to one of C, D0, D1, and D2 of FIG. 6.

In addition, the MVP candidate list may include a combined MVP candidate. The combined MVP candidate of the current block may be determined by determining the MVs of the adjacent blocks of the current block as the CPMVs of the current block and combining the CPMVs of the current block. The method of determining the MVP of each CPMV of the combined MVP candidate may be performed in the same manner as the method of determining the CPMV of the combined merge candidate. For example, MVP₀, MVP₁, MVP₂ and MVP₃ may be derived from the upper left adjacent block, the lower left adjacent block, the upper right adjacent block, and the temporally corresponding block, respectively. Alternatively, MVP₃ may be derived from MVP₀, MVP₁ and MVP₂. Additionally, if one MV among the upper left adjacent block, lower left adjacent block, upper right adjacent block, and temporally corresponding block is not available (e.g., the block does not exist or is intra-predicted), an MVP corresponding to the block for which the MV is not available may be derived from three MVPs derived from three blocks for which the MV is available.

When an MVP is selected from the MVP list, the MV is determined by adding the motion vector difference (MVD) obtained from the bitstream to the MVP. The MVD value may be applied to all CPMVs of the current block. For example, if the CPMV of the current block is 4, the MVD value for each MVP for the 4 CPMVs may be encoded or decoded. Specifically, for MVP₀, MVP₁, MVP₂ and MVP₃, MVD₀, MVD₁, MVD₂ and MVD₃ may be determined or obtained, respectively.

According to one embodiment, MV₀, MV₁, MV₂ and MV₃ may be determined as MVP₀+MVD₀, MVP₁+MVD₁, MVP₂+MVD₂ and MVP₃+MVD₃, respectively. Alternatively, MV₀, MV₁, MV₂ and MV₃ may be determined as MVP₀+MVD₀, MVP₁+MVD₀+MVD₁, MVP₂+MVD₀+MVD₂ and MVP₃+MVD₀+MVD₃, respectively.

Hereinafter, a method of deriving a CPMV used for affine model-based prediction in the encoding process from Equations 13 to 23 will be described.

In the following Equation, MV₀ represents the upper left CPMV, MV₀^{h} represents the horizontal component (x component) of the upper left CPMV, and MVₒ^{v} represents the vertical component (y component) of the upper left CPMV. MV₁ represents the upper right CPMV, MV₁^{h} represents the horizontal component (x component) of the upper right CPMV, and MV₁^{v} represents the vertical component (y component) of the upper right CPMV. MV_{(x,y)} represents a motion vector determined using the upper right CPMV and the upper left CPMV at (x,y) coordinates, MV_{(x,y)}^{h} represents the horizontal component (x component) of (x,y) coordinates, and MV_{(x,y)}^{v} represents the vertical component (y component) of (x,y) coordinates. In addition, W represents the width of the current block. In addition, p represents the (x,y) coordinate, and therefore, MV(p) represents MV_{(x,y)}.

Equations 13 to 15 illustrate a method of deriving the motion vector of (x,y) coordinates in the 4-parameter affine motion model. Equation 13 illustrates the derivation of MV_{(x,y)}^{h}, which is the horizontal component of (x,y) coordinates. In addition, Equation 14 illustrates the derivation of MV_{(x,y)}^{v}, which is the vertical component of (x,y) coordinates.

$$\begin{matrix}{MV}_{( x , y )}^{h} = \frac{M {V}_{1}^{h} − M {V}_{0}^{h}}{W} x - \frac{M {V}_{1}^{v} − M {V}_{0}^{v}}{W} y + M {V}_{0}^{h} \\ = ( 1 - \frac{x}{W} ) {MV}_{0}^{h} + \frac{x}{W} {MV}_{1}^{h} + \frac{y}{W} {MV}_{0}^{v} + \frac{y}{H} M {V}_{1}^{v}\end{matrix} \qquad [ Equation 13 ]$$

$$\begin{matrix}{MV}_{( x , y )}^{v} = \frac{{mV}_{1}^{v} − M {V}_{0}^{v}}{W} x - \frac{{MV}_{1}^{h} − {MV}_{0}^{h}}{W} y + {MV}_{0}^{v} \\ = - \frac{y}{W} {MV}_{0}^{h} + \frac{y}{H} {MV}_{1}^{h} + ( 1 - \frac{x}{W} ) {MV}_{0}^{v} + \frac{y}{H} M {V}_{1}^{v}\end{matrix} \qquad [ Equation 14 ]$$

By merging Equations 13 and 14 above, it may be expressed as Equation 15.

$$\vec{M V} ( p ) = A ( p ) \vec{M {V}_{c o r}} \qquad [ Equation 15 ]$$

$$\vec{M V} ( p ) ≡ ( {M {V}_{( x , y )}^{h} \atop M {V}_{( x , y )}^{v}} ) \text{} \qquad A ( p ) = [ \begin{matrix}{m}_{0} & {m}_{1} & {n}_{0} & - {n}_{0} \\ - {n}_{0} & {n}_{0} & {m}_{0} & {m}_{1}\end{matrix} ]$$

$${\vec{M V}}_{c o r} ≡ ( \begin{matrix}M {V}_{0}^{h} \\ M {V}_{1}^{h} \\ M {V}_{0}^{v} \\ M {V}_{1}^{v}\end{matrix} )$$

In Equation 15 above, m₀ represents (1−x/W), m₁ represents x/W, and n₀ represents y/W.

Equations 16 to 18 illustrate the method of deriving the motion vector of (x,y) coordinates in the 6-parameter affine motion model. Equation 16 illustrates the derivation of MV_{(x,y)}^{h}, the horizontal component of (x,y) coordinates. In addition, Equation 17 illustrates the derivation of MV_{(x,y)}^{v}, the vertical component of (x,y) coordinates.

$$\begin{matrix}M {V}_{( x , y )}^{h} = \frac{M {V}_{1}^{h} − M {V}_{0}^{h}}{W} x + \frac{M {V}_{2}^{h} − M {V}_{0}^{h}}{H} y + M {V}_{0}^{h} \\ = ( 1 − \frac{x}{W} − \frac{y}{H} ) M {V}_{0}^{h} + \frac{x}{W} M {V}_{1}^{h} + \frac{y}{H} M {V}_{2}^{h}\end{matrix} \qquad [ Equation 16 ]$$

$$\begin{matrix}M {V}_{( x , y )}^{v} = \frac{M {V}_{1}^{v} − M {V}_{0}^{v}}{W} x + \frac{M {V}_{2}^{v} − M {V}_{0}^{v}}{H} y + M {V}_{0}^{v} \\ = ( 1 − \frac{x}{W} − \frac{y}{H} ) M {V}_{0}^{v} + \frac{x}{W} M {V}_{1}^{v} + \frac{y}{H} M {V}_{2}^{v}\end{matrix} \qquad [ Equation 17 ]$$

By merging Equations 16 and 17 above, it may be expressed as Equation 18.

$$\vec{M V} ( p ) = A ( p ) \vec{M {V}_{c o r}} \qquad [ Equation 18 ]$$

$$\vec{M V} ( p ) ≡ ( {M {V}_{( x , y )}^{h} \atop M {V}_{( x , y )}^{v}} ) \text{} \qquad A ( p ) = [ \begin{matrix}{m}_{0} & {m}_{1} & {m}_{2} & 0 & 0 & 0 \\ 0 & 0 & 0 & {m}_{0} & {m}_{1} & {m}_{2}\end{matrix} ]$$

$${\vec{M V}}_{c o r} ≡ ( \begin{matrix}M {V}_{0}^{h} \\ M {V}_{1}^{h} \\ M {V}_{2}^{h} \\ M {V}_{0}^{v} \\ M {V}_{1}^{v} \\ M {V}_{2}^{v}\end{matrix} )$$

In Equation 18 above, m₀ represents (1−x/W−y/H), m₁ represents x/W, and m₂ represents y/H.

An MV that minimizes the MSE (Mean Square Error) of the current block and the prediction block is searched from the periphery of MV(p) determined by Equations 13 to 18. The MSE may be calculated by Equation 19 below. In Equation 19, p represents the position of the current pixel, B represents all pixels of the current block, and MV(p) represents the MV for p. In addition, P_{org}(p) represents the current block, and P_{ref}(p+MV(p)) represents the reference block at a position shifted by MV(p) from the position of the current block in the reference picture.

$$ε = M SB = {\sum }_{p ∈ B} {( {P}_{org} ( p ) - {P}_{ref} ( p + MV ( p ) ) )}^{2} \qquad [ Equation 19 ]$$

When the MV of p in the i-th iteration is MVⁱ(p), the method of assuming that the minimum MSE is obtained in the i+1-th iteration where the MV_{cor}ⁱ of the vertex of the block is changed by dMV_{cor}ⁱ is explained by Equation 20. In Equation 20, q represents (p+ MV(p)), which is the corresponding point corresponding to p of the reference block in the i-th iteration.

$$M {V}^{i + 1} ( p ) = A ( p ) ( M {V}_{c o r}^{i} + {dMV}_{c o r}^{i} ) = M {V}^{i} ( p ) + A ( p ) {dM V}_{c o r}^{i} \qquad [ Equation 20 ]$$

$${P}_{ref} ( p + M {V}^{i + 1} ( p ) ) = {p}_{ref} ( p + M {V}^{i} ( p ) + A ( p ) d M {V}_{c o r}^{i} ) = {p}_{ref} ( q + A ( p ) d M {V}_{c o r}^{i} )$$

In addition, by deriving (+⁽⁺¹⁾( )) of Equation 20 through Taylor series, Equation 21 is derived. In Equation 21, ′(q) represents horizontal and vertical differentiation at q.

$${P}_{ref} ( p + M {V}^{i + 1} ( p ) ) = {P}_{ref} ( q ) + {P}_{ref}^{′} ( q ) A ( p ) d M {V}_{c o r}^{i} \qquad [ Equation 21 ]$$

The horizontal differentiation (Gx) and vertical differentiation (Gy) may be calculated using the Sobel operator of Equation 22.

$$P i {c}_{ref}^{′} ( x , y ) = [ \begin{matrix}\{ ( P i {c}_{ref} ( x + 1 , y + 1 ) − P i {c}_{ref} ( x − 1 , y + 1 ) ) + & \{ ( Pi {c}_{ref} ( x + 1 , y + 1 ) − P i {c}_{ref} ( x + 1 , y - 1 ) ) + \\ 2 ( {Pic}_{ref} ( x + 1 , y ) − P i {c}_{ref} ( x − 1 , y ) ) , + & 2 ( {Pic}_{ref} ( x , y + 1 ) − P i {c}_{ref} ( x , y - 1 ) ) + \\ ( Pi {c}_{ref} ( x + 1 , y − 1 ) − P i {c}_{ref} ( x − 1 , y − 1 ) ) \} / 8 & ( Pi {c}_{ref} ( x - 1 , y + 1 ) − P i {c}_{ref} ( x − 1 , y − 1 ) ) \} / 8\end{matrix} ] \qquad [ Equation 22 ]$$

Alternatively, horizontal differentiation (Gx) and vertical differentiation (Gy) may use the Prewitt operator of Equation 23 by changing the Weight from 2 to 1 instead of the Sobel operator.

$$P i {c}_{ref}^{′} ( x , y ) = [ \begin{matrix}\{ ( P i {c}_{ref} ( x + 1 , y + 1 ) − P i {c}_{ref} ( x − 1 , y + 1 ) ) + & \{ ( Pi {c}_{ref} ( x + 1 , y + 1 ) − P i {c}_{ref} ( x + 1 , y - 1 ) ) + \\ ( Pi {c}_{ref} ( x + 1 , y ) − P i {c}_{ref} ( x − 1 , y ) ) , + & ( Pi {c}_{ref} ( x , y + 1 ) − P i {c}_{ref} ( x , y - 1 ) ) + \\ ( Pi {c}_{ref} ( x + 1 , y − 1 ) − P i {c}_{ref} ( x − 1 , y − 1 ) ) \} / 6 & ( Pi {c}_{ref} ( x - 1 , y + 1 ) − P i {c}_{ref} ( x − 1 , y − 1 ) ) \} / 6\end{matrix} ] \qquad [ Equation 23 ]$$

Based on Equation 21, ε representing MSE is determined according to Equation 24.

$$[ Equation 24 ]$$

$$\begin{matrix}ε = {min}_{{dMV}_{c o r}^{i}} {\sum }_{p ∈ B} {( {P}_{o r g} ( p ) − {P}_{ref} ( p + M {V}^{i + 1} ( p ) ) )}^{2} \\ {min}_{{dMV}_{c o r}^{i}} {\sum }_{p ∈ B} {( {P}_{o r g} ( \vec{p} ) − {P}_{ref} ( q ) − {P}_{ref}^{′} ( q ) A ( p ) {dMV}_{c o r}^{i} )}^{2} \\ {min}_{{dMV}_{c o r}^{i}} {\sum }_{p ∈ B} {( e ( p ) − {P}_{ref}^{′} ( q ) A ( p ) {dMV}_{c o r}^{i} )}^{2}\end{matrix}$$

$$e ( p ) = {P}_{o r g} ( \vec{p} ) − {P}_{ref} ( q )$$

Here, a variable dMV_{cor}ⁱ is solved according to Equation 25 so that ε(MSE) becomes 0.

$$\frac{\partial ε}{\partial dM {V}_{c o r}^{i}} 0 ⇔ 2 {\sum }_{p ∈ B} ( e ( p ) − {p}_{ref}^{′} ( q ) A ( p ) {dMV}_{c o r}^{i} ) ( − 1 ) {P}_{ref}^{′} ( q ) A ( p ) = 0 \qquad [ Equation 25 ]$$

$${\sum }_{p ∈ B} e ( p ) {P}_{ref}^{′} ( q ) A ( p ) = {\sum }_{p ∈ B} {P}_{ref}^{′} ( q ) A ( p ) {dmV}_{c o r}^{i} {P}_{ref}^{′} ( q ) A ( p )$$

$${P}_{ref}^{′} ( q ) = ( {q}_{x} , {q}_{y} )$$

Here, P′_{ref}(q) means gradient x and gradient y.

Referring to Equation 20, the following process may be iterated starting from i=0. That is, Equation 20 is iterated until dMV_{cor}ⁱ is almost (0,0), and MVⁱ⁺¹(p) is calculated. Alternatively, if dMV_{cor}ⁱ is very small, the above iteration may be stopped and MVⁱ⁺¹(p) may be calculated. Once the calculation of MV_{cor}ⁱ⁺¹ is completed, the equations related to MV^{h}(x,y) and MV^{v}(x,y) may be used.

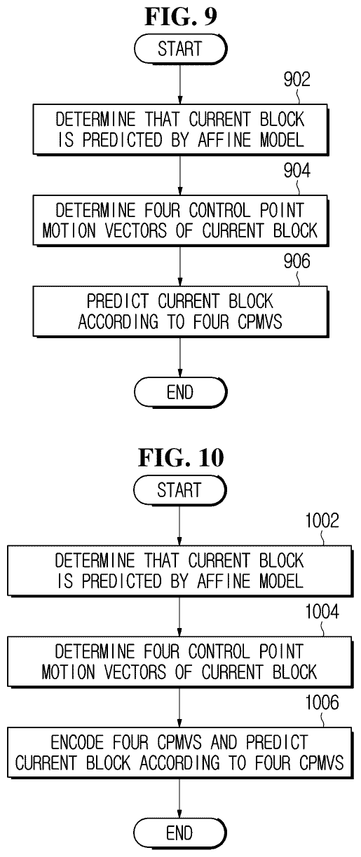

FIG. 9 illustrates a flowchart of a video decoding method of the present invention.

In step 902, it is determined that a current block is predicted by the affine model.

In step 904, four CPMVs of the current block are determined.

In step 906, the current block is predicted based on the four CPMVs.

Various embodiments may be applied to the method of determining the four CPMVs in step 904.

According to one embodiment, when the prediction mode of the current block is the merge mode, a merge candidate list including at least one of a spatial merge candidate, a temporal merge candidate, and a combined merge candidate of the current block may be determined. In addition, according to a merge candidate selected from the merge candidate list of the current block, four CPMVs of the current block may be determined.

According to one embodiment, if a spatial adjacent block of a current block is predicted by an affine model, a spatial merge candidate of the current block may be determined from the CPMV of the spatial adjacent block of the current block. In addition, if a temporally corresponding block of the current block is predicted by an affine model, a temporal merge candidate of the current block may be determined from the CPMV of the temporally corresponding block of the current block.

According to one embodiment, in determining the spatial merge candidate of the current block, if three CPMVs are used for prediction of the spatial adjacent block, a first CPMV, a second CPMV, and a third CPMV of the spatial merge candidate may be determined from the three CPMVs of the spatial adjacent block. A fourth CPMV of the spatial merge candidate may be derived from the first CPMV, the second CPMV, and the third CPMV of the spatial merge candidate. The present embodiment may also be applied to determining a temporal merge candidate.

According to one embodiment, in deriving the fourth CPMV of the spatial merge candidate, a prediction value of the fourth CPMV is determined from the first CPMV, the second CPMV, and the third CPMV of the spatial merge candidate, a difference value of the fourth CPMV is determined, and the fourth CPMV may be derived from the prediction value and the difference value of the fourth CPMV. This embodiment may also be applied in determining a temporal merge candidate.

According to one embodiment, in the step of determining the spatial merge candidate of the current block, if two CPMVs are used for prediction of the spatial adjacent block, a first CPMV and a second CPMV of the spatial merge candidate may be determined from the two CPMVs of the spatial adjacent block. A third CPMV and a fourth CPMV of the spatial merge candidate may be derived from the first CPMV and the second CPMV of the spatial merge candidate. The present embodiment may also be applied to determining a temporal merge candidate.

According to one embodiment, in deriving the third CPMV and the fourth CPMV of the spatial merge candidate, the prediction values of the third CPMV and the fourth CPMV may be determined from the first CPMV and the second CPMV of the spatial merge candidate, and the difference value of the third CPMV and the difference value of the fourth CPMV may be determined. In addition, the third CPMV may be derived from the prediction value and the difference value of the third CPMV, and the fourth CPMV may be derived from the prediction value and the difference value of the fourth CPMV. The present embodiment may also be applied in determining a temporal merge candidate.

According to one embodiment, in determining the merge candidate list of the current block, a plurality of motion vectors may be extracted from spatially adjacent blocks and temporally corresponding blocks of the current block, and a combined merge candidate may be determined by combining the plurality of motion vectors.

According to one embodiment, in extracting the plurality of motion vectors, a first CPMV, a second CPMV, and a third CPMV may be derived from a plurality of spatially adjacent blocks of the current block, and a fourth CPMV may be derived from a temporally corresponding block corresponding to a central position or a lower right position of the current block.

According to one embodiment, in extracting the plurality of motion vectors, a first CPMV, a second CPMV, and a third CPMV may be derived from a plurality of spatially adjacent blocks and temporally adjacent blocks of a current block, and a fourth CPMV may be derived from the first CPMV, the second CPMV, and the third CPMV.

According to one embodiment, in deriving the fourth CPMV, a prediction value of the fourth CPMV may be determined from the first CPMV, the second CPMV, and the third CPMV, and a difference value of the fourth CPMV may be determined. In addition, the fourth CPMV may be derived based on the prediction value and the difference value of the fourth CPMV.

According to one embodiment, the step of determining four CPMVs of the current block may include determining an MVP candidate list including at least one of a spatial MVP candidate, a temporal MVP block, or a combined MVP candidate of the current block when the prediction mode of the current block is an MVP mode. The four CPMVs of the current block may be determined according to an MVP candidate selected from the MVP candidate list of the current block.

According to one embodiment, if the spatially adjacent block of the current block is predicted by the affine model, a spatial MVP candidate of the current block may be determined from the CPMV of the spatially adjacent block of the current block. In addition, if the temporally corresponding block of the current block is predicted by the affine model, a temporal MVP candidate of the current block may be determined from the CPMV of the temporally corresponding block of the current block.

According to one embodiment, in determining the spatial MVP candidate of the current block, if three CPMVs are used for prediction of the spatially adjacent block, a first CPMVP, a second CPMVP, and a third CPMVP of the spatial MVP candidate may be determined from the three CPMVs of the spatially adjacent block. A fourth CPMVP of the spatial MVP candidate may be derived from the first CPMVP, the second CPMVP, and the third CPMVP of the spatial MVP candidate. This embodiment may also be applied in determining a temporal MVP candidate.

According to one embodiment, in determining the spatial MVP candidate of the current block, if two CPMVs are used for prediction of the spatially adjacent block, a first CPMVP and a second CPMVP of the spatial MVP candidate may be determined from three CPMVs of the spatially adjacent block. A third CPMVP and a fourth CPMVP of the spatial MVP candidate may be derived from the first CPMVP and the second CPMVP of the spatial MVP candidate. This embodiment may also be applied in determining a temporal MVP candidate.

According to one embodiment, in determining the MVP candidate list of the current block, a plurality of motion vectors may be extracted from spatially adjacent blocks and temporally corresponding blocks of the current block. A combined MVP candidate may be determined by combining the plurality of motion vectors.

According to one embodiment, in extracting the plurality of motion vectors, a first CPMVP, a second CPMVP, and a third CPMVP may be derived from a plurality of spatially adjacent blocks of the current block, and a fourth CPMVP may be derived from a temporally corresponding block corresponding to a central position or a lower right position of the current block.

According to one embodiment, in extracting the plurality of motion vectors, a first CPMVP, a second CPMVP, and a third CPMVP may be derived from a plurality of spatially adjacent blocks and temporally adjacent blocks of the current block. A fourth CPMVP may be derived from the first CPMVP, the second CPMVP, and the third CPMVP.

FIG. 10 illustrates a flowchart of a video encoding method of the present invention.

In step 1002, it is determined that a current block is predicted by an affine model.

In step 1004, four CPMVs of the current block are determined.

In step 1006, four CPMVs are encoded, and the current block is predicted based on the four CPMVs.

In step 1004, four CPMVs may be determined based on Equations 13 to 23.

In step 1006, four CPMVs may be encoded, according to various embodiments.

According to one embodiment, it may be determined whether the prediction mode of the current block is a merge mode or MVP mode.

According to one embodiment, when the prediction mode of the current block is a merge mode, a merge candidate list including at least one of a spatial merge candidate, a temporal merge candidate, or a combined merge candidate of the current block may be determined. According to one embodiment, the merge candidate list of the current block may be determined according to the embodiment discussed in the decoding method of FIG. 9.

Information indicating a merge candidate among the merge candidate list of the current block may be encoded. In addition, a difference value of the fourth CPMV for determining the fourth CPMV of the merge candidate applied to the current block may be encoded. In addition, according to an embodiment, a difference value of the third CPMV for determining the third CPMV of the merge candidate applied to the current block may be further encoded.

According to one embodiment, when the prediction mode of the current block is the MVP mode, an MVP candidate list including at least one of a spatial MVP candidate, a temporal MVP block, or a combined MVP candidate of the current block may be determined. According to one embodiment, the MVP candidate list of the current block may be determined according to the embodiment discussed in the decoding method of FIG. 9.

Information indicating an MVP candidate from the MVP candidate list of the current block may be encoded. In addition, four difference values indicating the differences between the four CPMVs applied to the current block and the four CPMVPs of the MVP candidates may be encoded.

The bitstream generated by the encoding method of FIG. 10 may be stored in a computer-readable recording medium. In addition, the bitstream generated by the encoding method of FIG. may be transmitted to another terminal, and the bitstream transmitted to another terminal may be decoded according to the decoding method of FIG. 9.

Hereinafter, an embodiment in which the current block is divided into two partitions and affine prediction is performed for each partition with a different CPMV will be described.

According to one embodiment, in the MVP mode, the CPMV of a partition of the current block is derived from the MV of an adjacent block of the current block. Specifically, the prediction value of the CPMV of the partition of the current block is determined from the referenced MV. In addition, the CPMV is derived by adding the difference value of the CPMV to the prediction value of each CPMV.

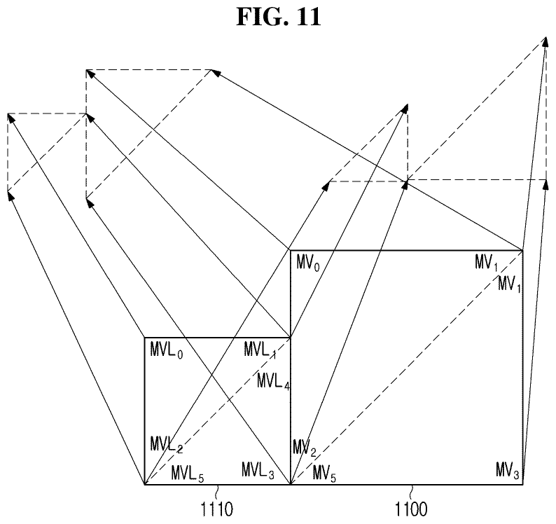

FIG. 11 illustrates a method of deriving six CPMVs of two partitions of a current block from one adjacent block.

According to FIG. 11, the prediction values of CPMVs of two partitions of a current block 1100 are derived based on six CPMVs of a neighboring block 1110 at the lower left of the current block 1100. For example, MV₀, MV₁, MV₂, MV₃, MV₄ and MV₅ of the current block 1100 may be derived based on MVL₀, MVL₁, MVL₂, MVL₃, MVL₄ and MVL₅ of the neighboring block 1110. The neighboring block 1110 of FIG. 11 is adjacent to the lower left of the current block 1100, but depending on the embodiment, the neighboring block 1110 may be adjacent to the upper right or upper left of the current block 1100.

FIG. 12 illustrates a method of deriving six CPMVs of two partitions of a current block from two adjacent blocks.

According to FIG. 12, a prediction value of a CPMV of an upper left partition 1202 of a current block 1200 is derived based on three CPMVs of a lower left neighboring block 1210 of the current block 1200. For example, MV₀, MV₁ and MV₂ of the current block 1200 may be derived based on MVL₀, MVL₁ and MVL₂ of the neighboring block 1210. In addition, the prediction value of the CPMV of a lower right partition 1204 of the current block 1200 is derived based on three CPMVs of an upper right neighboring block 1220 of the current block 1200. For example, MV₃, MV₄ and MV₅ of the current block 1200 may be derived based on MVT₃, MVT₄ and MVT₅ of the neighboring block 1220.

In FIG. 12, the prediction value of the CPMV of the upper left partition 1202 is depicted as being derived from the MV of the lower left neighboring block 1210, but according to an embodiment, it may be derived from the MV of the upper right neighboring block 1220.

Conversely, in FIG. 12, the prediction value of the CPMV of the lower right partition 1204 is depicted as being derived from the MV of the upper right neighboring block 1220, but according to an embodiment, it may be derived from the MV of the lower left neighboring block 1210.

Equation 24 below shows an embodiment of determining CPMV (MV₀, MV₁, MV₂, MV₃, MV₄, MV₅) by adding the prediction value of CPMV derived by the MV of the neighboring block and the difference value of CPMV.

$${MV}_{0} = {PMVL}_{0} + {MVD}_{0} \qquad [ Equation 26 ]$$

$${MV}_{1} = {PMVL}_{1} + {MVD}_{1}$$

$${MV}_{2} = {PMVL}_{2} + {MVD}_{2}$$

$${MV}_{3} = {PMVT}_{3} + {MVD}_{3}$$

$${MV}_{4} = {PMVT}_{4} + {MVD}_{4}$$

$${MV}_{5} = {PMVT}_{5} + {MVD}_{5}$$

According to Equation 26, PMVL₀, PMVL₁, PMVL₂, PMVT₃, PMVT₄ and PMVT₅ represent the prediction values MV₀, MV₁, MV₂, MV₃, MV₄ and MV₅ derived based on MVL₀, MVL₁, MVL₂, MVT₃, MVT₄ and MVT₅, respectively. In addition, MVD₀, MVD₁, MVD₂, MVD₃, MVD₄ and MVD₅ represent the difference values of MV₀, MV₁, MV₂, MV₃, MV₄ and MV₅.

Equation 27 shows another embodiment of determining CPMV (MV₀, MV₁, MV₂, MV₃, MV₄, MV₅).

$${MV}_{0} = {PMVL}_{0} + {MVD}_{0} \qquad [ Equation 27 ]$$

$${MV}_{1} = {PMVL}_{1} + {MVD}_{1} + {MVD}_{0}$$

$${MV}_{2} = {PMVL}_{2} + {MVD}_{2} + {MVD}_{0}$$

$${MV}_{3} = {PMVT}_{3} + {MVD}_{3} + {MVD}_{0}$$

$${MV}_{4} = {PMVT}_{4} + {MVD}_{4} + {MVD}_{0}$$

$${MV}_{5} = {PMVT}_{5} + {MVD}_{5} + {MVD}_{0}$$

According to Equation 27, MVD₀ is used to derive MV₀, MV₁, MV₂, MV₃, MV₄ and MV₅. In addition, MVD₁, MVD₂, MVD₃, MVD₄ and MVD₅ may be used to derive MV₁, MV₂, MV₃, MV₄ and MV₅. Therefore, when the difference between the values of MVD₀, MVD₁, MVD₂, MVD₃, MVD₄ and MVD₅ is small, the encoding rate of the difference value can be improved by parsing the difference value according to Equation 27.

In Equations 26 and 27, MV₃, MV₄ and MV₅ are described as being derived from PMVT₃, PMVT₄ and PMVT₅, but according to an embodiment, MV₃, MV₄ and MV₅ may be derived from PMVL₃, PMVL₄ and PMVL₅ obtained from MVL₃, MVL₄ and MVL₅. In addition, although MV₀, MV₁ and MV₂ are described as being derived from PMVL₀, PMVL₁ and PMVL₂, according to an embodiment, MV₀, MV₁ and MV₂ may be derived from PMVT₀, PMVT₁ and PMVT₂ obtained from MVT₀, MVT₁ and MVT₂.

According to another embodiment, depending on the merge mode, the CPMV of a partition of the current block is derived from the MV of an adjacent block of the current block. Specifically, the CPMV of a partition of the current block is determined from the referenced MV. In this case, the difference value of the CPMV is not parsed.

Equation 28 below describes an embodiment in which the CPMV of a partition of the current block is derived from the MV of an adjacent block of the current block in the merge mode.

$${MV}_{0} = {MVL}_{1} + \frac{{y}_{5} − {y}_{0}}{{y}_{6} − {y}_{4}} ( M V {L}_{2} − M V {L}_{0} ) ; P M V {L}_{0} \qquad [ Equation 28 ]$$

$$M {V}_{1} = M {V}_{0} + \frac{{x}_{1} − {x}_{0}}{{x}_{5} − {x}_{4}} ( M V {L}_{1} − M V {L}_{0} ) ; P M V {L}_{1}$$

$$M {V}_{2} = M {V}_{0} + \frac{{y}_{2} − {y}_{0}}{{y}_{6} − {y}_{4}} ( M V {L}_{2} − M V {L}_{1} ) ; P M V {L}_{2}$$

$$M {V}_{3} = M V {T}_{3} + \frac{{x}_{3} − {x}_{2}}{{x}_{8} − {x}_{7}} ( M V {T}_{3} − M V {T}_{2} ) ; P M V {T}_{3}$$

$$M {V}_{4} = M {V}_{3} + \frac{{y}_{3} − {y}_{1}}{{y}_{10} − {y}_{8}} ( M V {T}_{3} − M V {T}_{1} ) ; P M V {T}_{4}$$

$$M {V}_{5} = M {V}_{3} + \frac{{x}_{3} − {x}_{2}}{{x}_{10} − {x}_{9}} ( M V {T}_{3} − M V {T}_{2} ) ; P M V {T}_{3}$$

Equation 28 shows a CPMV derivation method when the current block references the lower left adjacent block and the upper right adjacent block. The CPMV derivation method according to Equation 28 may also be applied when the current block references other adjacent blocks.

Hereinafter, a method of improving prediction accuracy of partition boundaries when a current block is divided into two partitions and each partition is predicted by a different CPMV will be described.

When predicting different CPMVs for each partition, the prediction accuracy can be improved by taking a weighted average of the sample values of the partition boundaries determined for each partition when determining the sample values of the partition boundaries. The prediction method of the partition boundary sample is applied equally to the encoder and decoder.

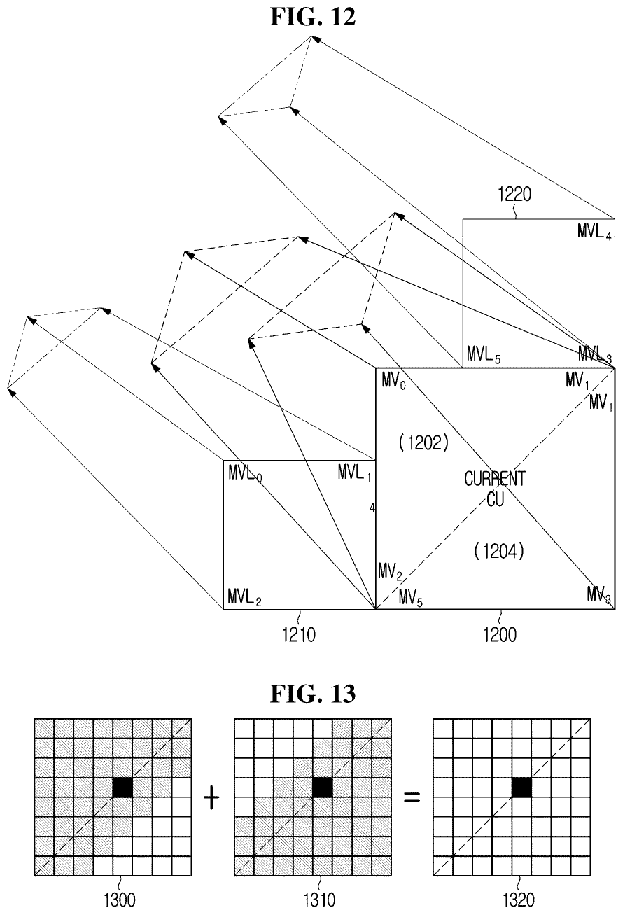

FIG. 13 illustrates a first prediction block, a second prediction block, and a final prediction block obtained by summing them.

A first prediction block 1300 is a prediction block that includes only predicted samples for an upper left partition. A second prediction block 1310 is a prediction block that includes only predicted samples for a lower right partition. The gray areas of the first prediction block 1300 and the second prediction block 1310 indicate samples for which prediction values are calculated in each block.

The gray area of the first prediction block 1300 includes partition boundary adjacent samples together with the upper left partition. In addition, the gray area of the second prediction block 1310 includes partition boundary adjacent samples together with the lower right partition. For example, in FIG. 13, the partition boundary adjacent samples include samples that are two sample units away from the partition boundary. The shape and size of the gray areas of the first prediction block 1300 and the second prediction block 1310 of FIG. 13 may be changed. Additionally, depending on the embodiment, the gray area may include the entire area of the block.

A final prediction block 1320 is derived by a weighted sum of the first prediction block 1300 and the second prediction block 1310. At this time, depending on the position of each sample, the weight applied to the first prediction block 1300 and the weight applied to the second prediction block 1310 may differ.

Equation 29 below is an example of an equation for calculating sample values of the final prediction block 1320 using sample values at the same position obtained from the first prediction block 1300 and the second prediction block 1310.

p₍ₓ₎=w*blockTop_{(x,y)}+(4−w)*blockBottom_{(x,y)}>>2 [Equation 29]

In Equation 29, w represents a weight. The weight w may be changed, and different values may be used depending on the block size. Equation 29 may vary depending on the weight w.

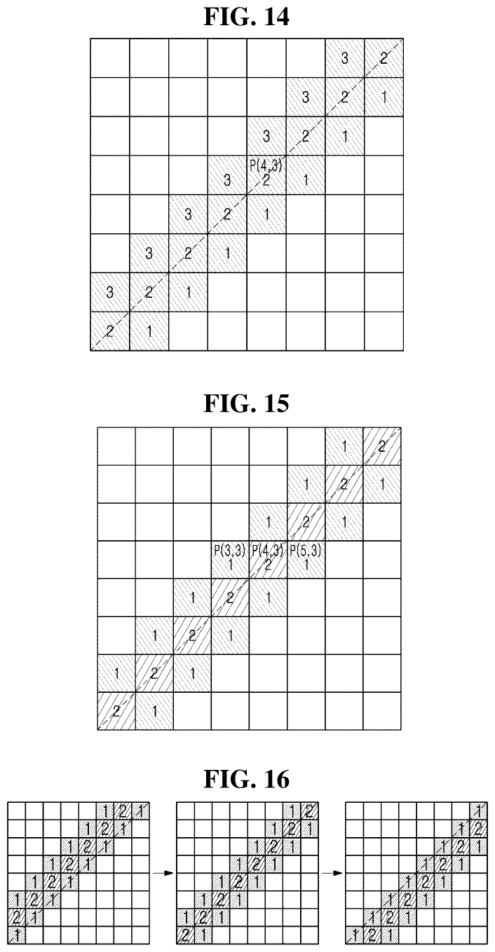

FIG. 14 illustrates an embodiment of a weight of each sample used in calculation of a final prediction block 1320.

The diagonal dotted lines in FIG. 14 represent partition boundaries. In addition, the gray samples in FIG. 14 are the sample areas where the weighted sum is calculated according to Equation 29. The numbers for the gray samples in FIG. 14 represent weights, which may be used as the w values in Equation 29.

Equation 30 is an example of calculating the p(4,3) sample value of FIG. 14.

p_{(4,3)}=2*blockTop_{(4,3)}+2*blockBottom_{(4,3)}>>2 [Equation 30]

In another embodiment, the prediction accuracy of the partition boundary can be improved by applying a low-pass filter to the partition boundary.

FIG. 15 illustrates an embodiment of applying a low-pass filter to samples at a partition boundary of a current block.

According to FIG. 15, samples at the partition boundary may be filtered with reference to the surrounding samples. As an example of applying a low-pass filter, Equation 31 provides an example of a method of using a [1, 2, 1] low-pass filter in p(4,3) samples.

p_{(4,3)}=p_{(3,3)}+2*p_{(4,3)}+p_{(5,3)}>>2 [Equation 31]

The low-pass filter of Equation 31 is only an example, and depending on the embodiment, the location and number of referenced surrounding samples and the filter coefficients of the low-pass filter may vary.

FIG. 16 illustrates an embodiment of applying a low-pass filter to samples at a partition boundary of a current block and samples adjacent to a current partition boundary.

The range of samples to which the low-pass filter is applied may be expanded depending on the embodiment.

The various embodiments of the present disclosure are not intended to list all possible combinations but rather to illustrate representative aspects of the present disclosure, and the matters described in the various embodiments may be applied independently or in combinations of two or more.

In addition, various embodiments of the present disclosure may be implemented by hardware, firmware, software, or a combination thereof. In the case of implementing the present invention by hardware, the present invention can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the present disclosure includes software or machine-executable instructions (e.g., operating systems, applications, firmware, programs, etc.) that cause operations according to the methods of various embodiments to be executed on a device or a computer, and a non-transitory computer-readable medium having such software or instructions stored thereon and executable on the device or computer.

1. A video decoding method comprising:
determining that a current block is predicted by an affine model;
determining four control point motion vectors (CPMVs) of the current block; and
predicting the current block according to the four CPMVs.

2. The video decoding method of claim 1, wherein the determining the four CPMVs of the current block comprises:
determining a merge candidate list including at least one of a spatial merge candidate, a temporal merge candidate or a combined merge candidate of the current block when a prediction mode of the current block is a merge mode; and
determining the four CPMVs of the current block according to a merge candidate selected from the merge candidate list of the current block.

3. The video decoding method of claim 2, wherein the determining the merge candidate list of the current block comprises:
determining a spatial merge candidate of the current block from a CPMV of a spatially adjacent block of the current block when the spatially adjacent block of the current block is predicted by an affine model; and
determining a temporal merge candidate of the current block from a CPMV of a temporally corresponding block of the current block when the temporally corresponding block of the current block is predicted by an affine model.

4. The video decoding method of claim 3, wherein the determining the spatial merge candidate of the current block comprises:
determining a first CPMV, a second CPMV and a third CPMV of the spatial merge candidate from three CPMVs of the spatially adjacent block when three CPMVs are used for prediction of the spatially adjacent block; and
deriving a fourth CPMV of the spatial merge candidate from the first CPMV, the second CPMV and the third CPMV of the spatial merge candidate.

5. The video decoding method of claim 4, wherein the deriving the fourth CPMV of the spatial merge candidate comprises:
determining a prediction value of the fourth CPMV from the first CPMV, the second CPMV and the third CPMV of the spatial merge candidate;
determining a difference value of the fourth CPMV; and
deriving the fourth CPMV from the prediction block and the difference value of the fourth CPMV.

6. The video decoding method of claim 3, wherein the determining the spatial merge candidate of the current block comprises:
determining a first CPMV and a second CPMV of the spatial merge candidate from two CPMVs of the spatially adjacent block when two CPMVs are used for prediction of the spatially adjacent block; and
deriving a third CPMV and a fourth CPMV of the spatial merge candidate from the first CPMV and the second CPMV of the spatial merge candidate.

7. The video decoding method of claim 6, wherein the deriving the third CPMV and the fourth CPMV of the spatial merge candidate comprises:
determining prediction values of the third CPMV and the fourth CPMV from the first CPMV and the second CPMV of the spatial merge candidate;
determining a difference value of the third CPMV and a difference value of the fourth CPMV; and
deriving the third CPMV from the prediction value and the difference value of the third CPMV and deriving the fourth CPMV from the prediction value and the difference value of the fourth CPMV.

8. The video decoding method of claim 2, wherein the determining the merge candidate list of the current block comprises:
extracting a plurality of motion vectors from the spatially adjacent block and the temporally corresponding block of the current block; and
determining a combined merge candidate by combining the plurality of motion vectors.

9. The video decoding method of claim 8, wherein the extracting the plurality of motion vectors comprises deriving a first CPMV, a second CPMV and a third CPMV from a plurality of spatially adjacent blocks of the current block and deriving a fourth CPMV from a temporally corresponding block corresponding to a center position or a lower right position of the current block.

10. The video decoding method of claim 8, wherein the extracting the plurality of motion vectors comprises:
deriving a first CPMV, a second CPMV and a third CPMV from a plurality of spatially adjacent blocks and temporally corresponding blocks of the current block; and
deriving a fourth CPMV from the first CPMV, the second CPMV and the third CPMV.

11. The video decoding method of claim 10, wherein the deriving the fourth CPMV comprises:
determining a prediction block of the fourth CPMV from the first CPMV, the second CPMV and the third CPMV;
determining a difference value of the fourth CPMV; and
deriving the fourth CPMV based on the prediction value and the difference value of the fourth CPMV.

12. The video decoding method of claim 1, wherein the determining the fourth CPMVs of the current block comprises:
determining an MVP candidate list including at least one of a spatial MVP candidate, a temporal MVP block or a combined MVP candidate of the current block when a prediction mode of the current block is a motion vector prediction (MVP) mode; and
determining the four CPMVs of the current block according to an MVP candidate selected from the MVP candidate list of the current block.

13. The video decoding method of claim 12, wherein the determining the MVP candidate list of the current block comprises:
determining a spatial MVP candidate of the current block from a CPMV of a spatially adjacent block of the current block when the spatially adjacent block of the current block is predicted by an affine model; and
determining a temporal MVP candidate of the current block from a CPMV of a temporally corresponding block of the current block when the temporally corresponding block of the current block is predicted by an affine model.

14. The video decoding method of claim 13, wherein the determining the spatial MVP candidate of the current block comprises:
determining a first control point motion vector predictor (CPMVP), a second CPMVP and a third CPMVP of the spatial MVP candidate from three CPMVs of the spatially adjacent block when three CPMVs are used for prediction of the spatially adjacent block; and
deriving a fourth CPMVP of the spatial MVP candidate from the first CPMVP, the second CPMVP and the third CPMVP of the spatial MVP candidate.

15. The video decoding method of claim 13, wherein the determining the spatial MVP candidate of the current block comprises:
determining a first CPMVP and a second CPMVP of the spatial MVP candidate from three CPMVs of the spatially adjacent block when two CPMVs are used for prediction of the spatially adjacent block; and
deriving a third CPMVP and a fourth CPMVP of the spatial MVP candidate from the first CPMVP and the second CPMVP of the spatial MVP candidate.

16. The video decoding method of claim 12, wherein the determining the MVP candidate list of the current block comprises:
extracting a plurality of motion vectors from a spatially adjacent block and a temporally corresponding block of the current block; and
determining a combined MVP candidate by combining the plurality of motion vectors.

17. The video decoding method of claim 16, wherein the extracting the plurality of motion vectors comprises:
deriving a first CPMVP, a second CPMVP and a third CPMVP from a plurality of spatially adjacent blocks of the current block and deriving a fourth CPMVP from a temporally corresponding block corresponding to a center position or a lower right position of the current block.

18. The video decoding method of claim 16, wherein the extracting the plurality of motion vectors comprises:
deriving a first CPMVP, a second CPMVP and a third CPMVP from a plurality of spatially adjacent blocks of the current block; and
deriving a fourth CPMVP from the first CPMVP, the second CPMVP and the third CPMVP.

19. A video encoding method comprising:
determining that a current block is predicted by an affine model;
determining four CPMVs of the current block; and
encoding the four CPMVs and predicting the current block according to the four CPMVs.

20. A data transmission method of transmitting image data, the data transmission method comprising:
generating a bitstream by encoding image data according to an image encoding method; and
transmitting the generated bitstream,
wherein the image encoding method comprises:
determining that a current block is predicted by an affine model;
determining four CPMVs of the current block; and
encoding the four CPMVs and predicting the current block according to the four CPMVs.
